(19) United States
(12) Patent Application Publication
(10) Pub. No.: US 2024/0140072 A1
(43) Pub. Date: May 2, 2024

(54) FLEXIBLE COVER WINDOW WITH IMPROVED STRENGTH AND SURFACE HARDNESS

(71) Applicant: UTI INC., Yesan-gun (KR)

(72) Inventors: Kukhyun SUNWOO, Yesan-gun (KR); Tea Joo HA, Yesan-gun (KR); Jae Suk OH, Yesan-gun (KR)

(73) Assignee: UTI INC., Yesan-gun (KR)

(21) Appl. No.: 18/492,466

(22) Filed: Oct. 23, 2023

(30) Foreign Application Priority Data
Oct. 28, 2022 (KR) 10-2022-0141196
Oct. 12, 2023 (KR) 10-2023-0136306

(51) Int. Cl. B32B 17/10; B32B 3/30; B32B 7/022; B32B 7/12; B32B 27/36

(52) U.S. Cl. CPC B32B 17/10; B32B 3/30; B32B 7/022; B32B 7/12; B32B 27/36; B32B 2255/10; B32B 2307/51; B32B 2307/536; B32B 2307/54; B32B 2307/581; B32B 2307/7376; B32B 2457/20

(57) ABSTRACT

Disclosed is a glass-based flexible cover window with improved strength and surface hardness comprising a planar portion formed so as to correspond to a planar region of a flexible display and a folding portion formed so as to be connected to the planar portion, the folding portion being formed so as to correspond to a folding region of the flexible display, wherein the flexible cover window includes a flat glass substrate or a glass substrate having an embossed or engraved uneven pattern formed thereat, an adhesive buffer layer formed at a front surface of the glass substrate, a protective film layer formed on the adhesive buffer layer, and a hard coating layer formed on the protective film layer, and the adhesive buffer layer and the protective film layer are alternately stacked at least n times (where n is a natural number equal to or greater than 1).

### CROSS-REFERENCE TO RELATED APPLICATION

This application claims priority from Korean Patent Application Nos. 10-2022-0141196 filed on Oct. 28, 2022, and 10-2023-0136306 filed on Oct. 12, 2023, in the Korean Intellectual Property Office, the disclosures of which are incorporated herein by reference in their entireties.

### BACKGROUND OF THE INVENTION

### 1. Field of the Invention

The present invention relates to a flexible cover window, and more particularly to a flexible cover window with improved strength and surface hardness configured such that impact strength and surface hardness of the flexible cover window are excellent while aesthetics of the flexible cover window are improved.

### 2. Description of the Related Art

With recent rapid development of electric and electronic technologies and an increase in new demands of the times and various demands of consumers, various types of display products have been manufactured. Thereamong, research on a flexible display capable of being folded and unfolded has been actively conducted.

At first, research on folding the flexible display was conducted, and now research on bending, rolling, and stretching of the flexible display are being conducted. Not only a display panel but also a cover window configured to protect the display panel must be flexible, and therefore the cover window must be flexible and must have no wrinkles at the folding region thereof after repeated folding, and image distortion must not occur.

For a conventional cover window for flexible displays, a polymer film, such as a PI film or a PET film, is attached to the surface of a display panel. Since the mechanical strength of a simple polymer film is low, however, the polymer film serves merely to prevent scratches on the display panel. In addition, the polymer film has low resistance to shock and low transmittance. Furthermore, the polymer film is relatively expensive.

As the number of folds of the display increases, the folding region of the polymer film is wrinkled, whereby the folding region of the polymer film is damaged. For example, the polymer film is pressed or torn at the time of folding limit evaluation (generally 200,000 times).

In recent years, various research on a glass-based cover window has been conducted in order to overcome the limit of the polymer film cover window.

Such a glass-based cover window requires fundamental physical properties. For example, image distortion must not occur, and the glass-based cover window must have sufficient strength and surface hardness with respect to repetitive contact of a touch pen and specific pressure while folding properties must be satisfied.

In order to satisfy the strength properties of the flexible cover window, glass must have a specific thickness or more. In order to satisfy the folding properties of the flexible cover window, on the other hand, the glass must have a specific thickness or less. Consequently, research on the optimum thickness and structure of the flexible cover window at which image distortion does not occur while both the strength properties and the folding properties are satisfied is necessary.

In Korean Patent Application No. 10-2021-0102841, a protective film layer having a hard coating layer 400 formed at a front surface of a glass substrate is used as an adhesive buffer layer to improve a flexible cover window. However, in order to improve usability of a flexible cover window in daily life, to extend the lifespan of a device having the flexible cover window applied thereto, and to increase economy, there is a need for further research on a cover window having an appropriate thickness to secure strength while maintaining aesthetics and at the same time having further improved folding properties.

### SUMMARY OF THE INVENTION

The present invention has been made in view of the above problems and technical problems that have been requested from the past.

It is an object of the present invention to provide a flexible cover window configured such that an adhesive buffer layer and a protective film layer, which is joined to the adhesive buffer layer, are formed on a glass substrate having a predetermined shape at least once, whereby folding properties and aesthetics are excellent while strength and surface hardness are improved.

1. Even Structure

The present invention provides a glass-based flexible cover window with improved strength and surface hardness including a planar portion formed so as to correspond to a planar region of a flexible display and a folding portion formed so as to be connected to the planar portion, the folding portion being formed so as to correspond to a folding region of the flexible display, wherein the flexible cover window includes a flat glass substrate, an adhesive buffer layer formed at a front surface of the glass substrate, a protective film layer formed on the adhesive buffer layer, and a hard coating layer formed on the protective film layer, and the adhesive buffer layer and the protective film layer are alternately stacked at least n times (where n is a natural number equal to or greater than 1).

The planar portion and the folding portion of the glass substrate may have the same thickness.

At least one surface of the folding portion of the glass substrate may include an inclined portion, whereby the thickness of the folding portion may be less than the thickness of the planar portion.

The inclined portion of the folding portion may be any one of a forward type inclined portion configured such that the inclined portion is formed at a rear surface of the glass substrate, a reverse type inclined portion configured such that the inclined portion is formed at the front surface of the glass substrate, the reverse type inclined portion being a reversal of the forward type inclined portion, and a double-sided type inclined portion configured such that the inclined portion is formed at the front surface and the rear surface of the glass substrate.

The double-sided type inclined portion may be configured such that the depth of the inclined portion formed at the front surface and the depth of the inclined portion formed at the rear surface are equal to or different from each other.

The adhesive buffer layer may include an optically clear resin (OCR).

The protective film layer may include at least one selected from the group consisting of polyethylene terephthalate (PET), transparent polyimide (TPI), polyurethane (PU), polypropylene (PP), polyethylene naphthalate (PEN), and polycarbonate (PC).

The strength of the protective film layer at the planar portion and the strength of the protective film layer at the folding portion may be equal to or different from each other.

The protective film layer may have a thickness of 1 to 100 μm.

The flexible cover window may be configured such that an elastic buffer layer is optionally formed on the rear surface of the glass substrate.

The elastic buffer layer may include an optically clear resin (OCR).

When the adhesive buffer layer and the protective film layer are alternately stacked at least n+1 times in a stacking direction, compositions of n-th and (n+1)-th adhesive buffer layers may be identical to or different from each other, and compositions of n-th and (n+1)-th protective film layers may be identical to or different from each other (where n is a natural number equal to or greater than 1).

When the adhesive buffer layer and the protective film layer are alternately stacked at least n+1 times in the stacking direction, the thickness of an n-th adhesive buffer layer may be less than the thickness of an (n+1)-th adhesive buffer layer, and the thickness of an n-th protective film layer may be less than the thickness of an (n+1)-th protective film layer (where n is a natural number equal to or greater than 1).

2. Uneven Structure

In addition, the present invention provides a glass-based flexible cover window with improved strength and surface hardness including a planar portion formed so as to correspond to a planar region of a flexible display and a folding portion formed so as to be connected to the planar portion, the folding portion being formed so as to correspond to a folding region of the flexible display, wherein the flexible cover window includes a glass substrate having an embossed or engraved uneven pattern formed thereat, an adhesive buffer layer formed at a front surface of the glass substrate, a protective film layer formed on the adhesive buffer layer, and a hard coating layer formed on the protective film layer, and the adhesive buffer layer and the protective film layer are alternately stacked at least n times (where n is a natural number equal to or greater than 1).

The planar portion and the folding portion of the glass substrate may have the same thickness.

The planar portion and the folding portion of the glass substrate may have the same thickness, and the embossed or engraved uneven pattern may be formed at the front surface, a rear surface, or both surfaces of the glass substrate.

The planar portion and the folding portion of the glass substrate may have the same thickness, and the embossed or engraved uneven pattern may be formed at the folding portion of the glass substrate or at both the planar portion and the folding portion of the glass substrate.

At least one surface of the folding portion of the glass substrate may include an inclined portion, whereby the thickness of the folding portion may be less than the thickness of the planar portion.

The inclined portion of the folding portion may be any one of a forward type inclined portion configured such that the inclined portion is formed at a rear surface of the glass substrate, a reverse type inclined portion configured such that the inclined portion is formed at the front surface of the glass substrate, the reverse type inclined portion being a reversal of the forward type inclined portion, and a double-sided type inclined portion configured such that the inclined portion is formed at the front surface and the rear surface of the glass substrate.

The double-sided type inclined portion may be configured such that the depth of the inclined portion formed at the front surface and the depth of the inclined portion formed at the rear surface are equal to or different from each other.

At least one surface of the folding portion of the glass substrate may include an inclined portion, whereby the thickness of the folding portion may be less than the thickness of the planar portion, and the embossed or engraved uneven pattern may be formed at the front surface, the rear surface, or both surfaces of the glass substrate.

At least one surface of the folding portion of the glass substrate may include an inclined portion, whereby the thickness of the folding portion may be less than the thickness of the planar portion, and the embossed or engraved uneven pattern may be formed at the folding portion of the glass substrate or at both the planar portion and the folding portion of the glass substrate.

The planar portion of the glass substrate may have a thickness of 10 to 300 μm, and the folding portion of the glass substrate may have a thickness of 5 to 100 μm.

The adhesive buffer layer may include an optically clear resin (OCR).

The protective film layer may include at least one selected from the group consisting of polyethylene terephthalate (PET), transparent polyimide (TPI), polyurethane (PU), polypropylene (PP), polyethylene naphthalate (PEN), and polycarbonate (PC).

The strength of the protective film layer at the planar portion and the strength of the protective film layer at the folding portion may be equal to or different from each other.

The protective film layer may have a thickness of 1 to 100 μm.

The flexible cover window may be configured such that an elastic buffer layer is optionally formed on the rear surface of the glass substrate.

The elastic buffer layer may include an optically clear resin (OCR).

When the adhesive buffer layer and the protective film layer are alternately stacked at least n+1 times in a stacking direction, compositions of n-th and (n+1)-th adhesive buffer layers may be identical to or different from each other, and compositions of n-th and (n+1)-th protective film layers may be identical to or different from each other (where n is a natural number equal to or greater than 1).

When the adhesive buffer layer and the protective film layer are alternately stacked at least n+1 times in the stacking direction, the thickness of an n-th adhesive buffer layer may be less than the thickness of an (n+1)-th adhesive buffer layer, and the thickness of an n-th protective film layer may be less than the thickness of an (n+1)-th protective film layer (where n is a natural number equal to or greater than 1).

### BRIEF DESCRIPTION OF THE DRAWINGS

FIGS. 1A to 2H are schematic views of flexible cover windows according to the present invention; and

FIGS. 3 to 12L are partial schematic views of flexible cover windows to which various types of glass according to embodiments of the present invention are applied.

### DETAILED DESCRIPTION OF THE PREFERRED EMBODIMENTS

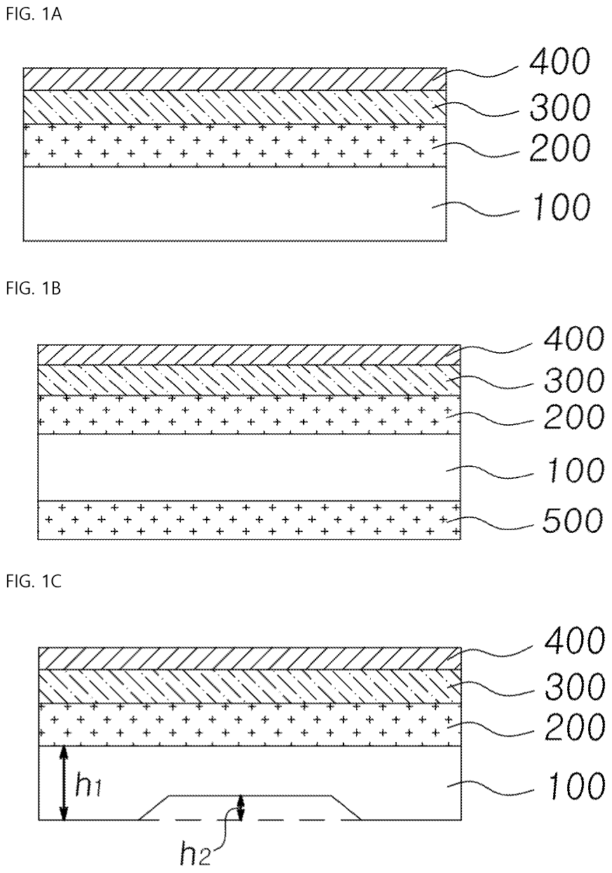

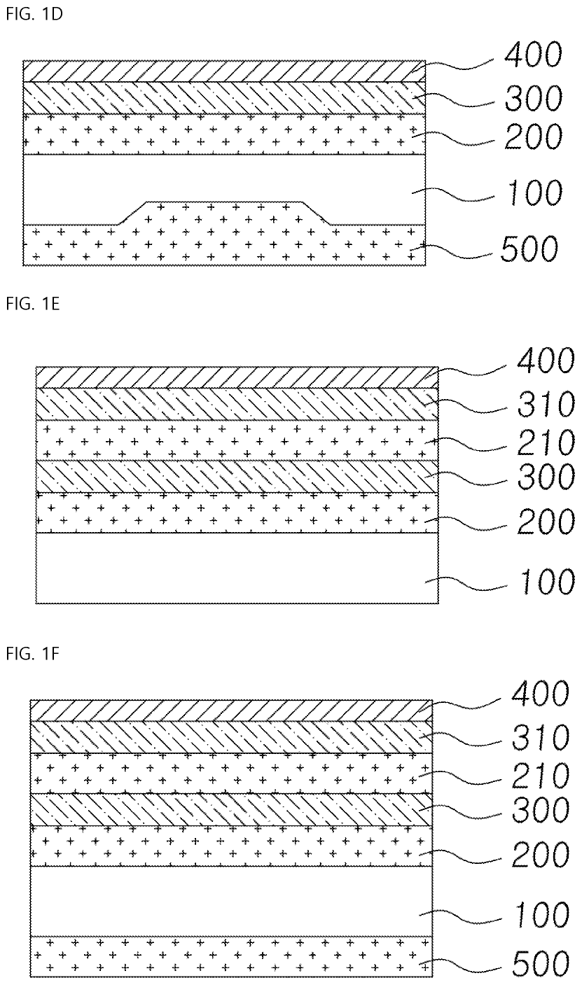

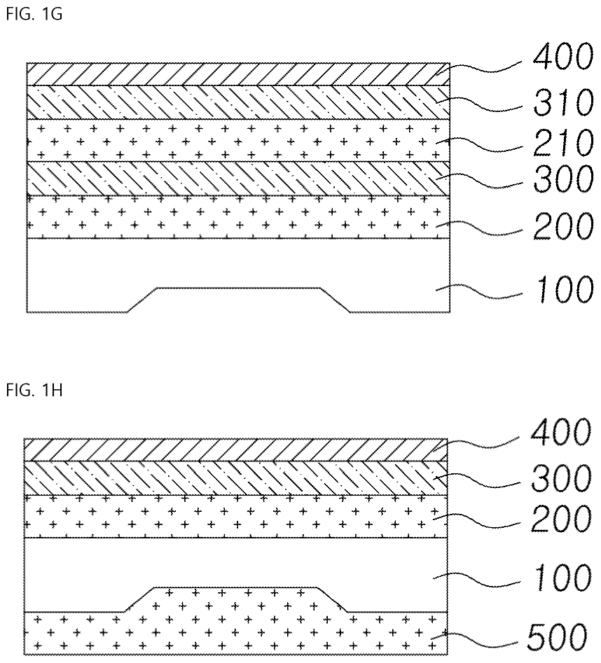

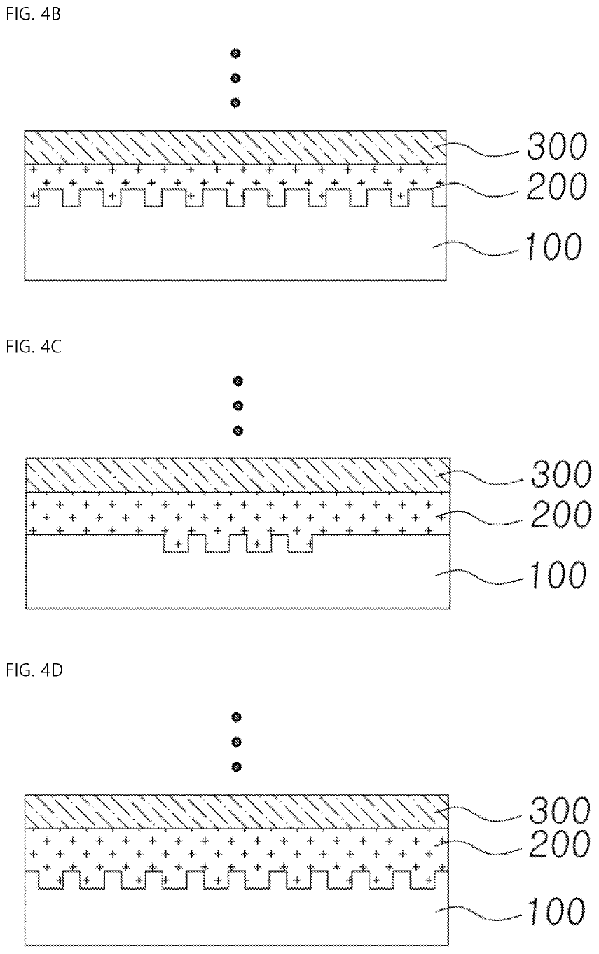

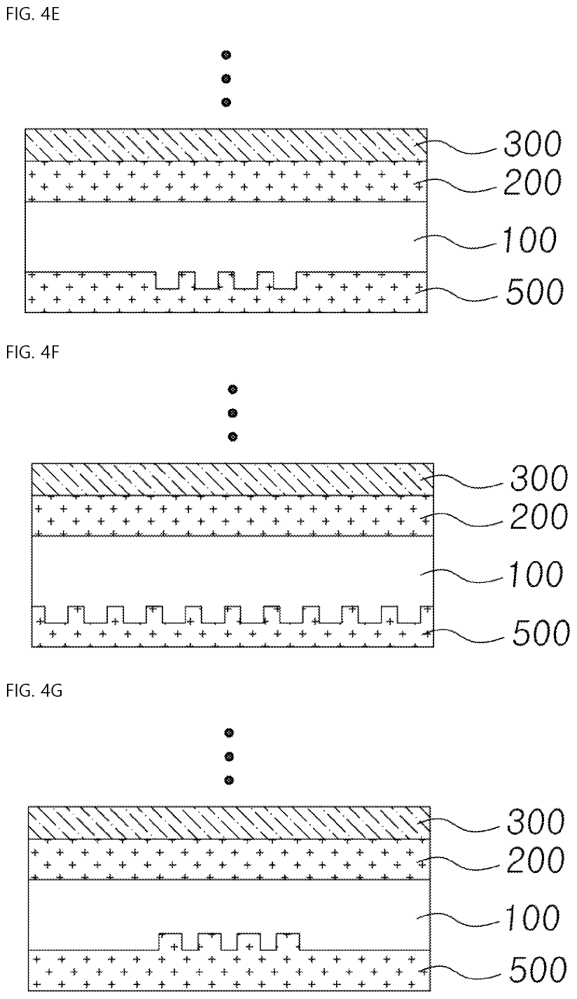

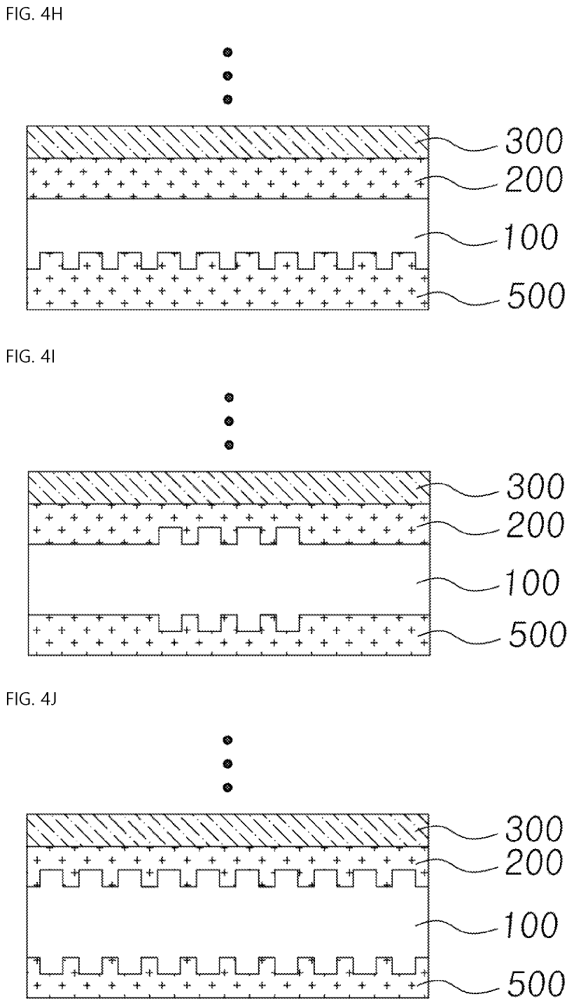

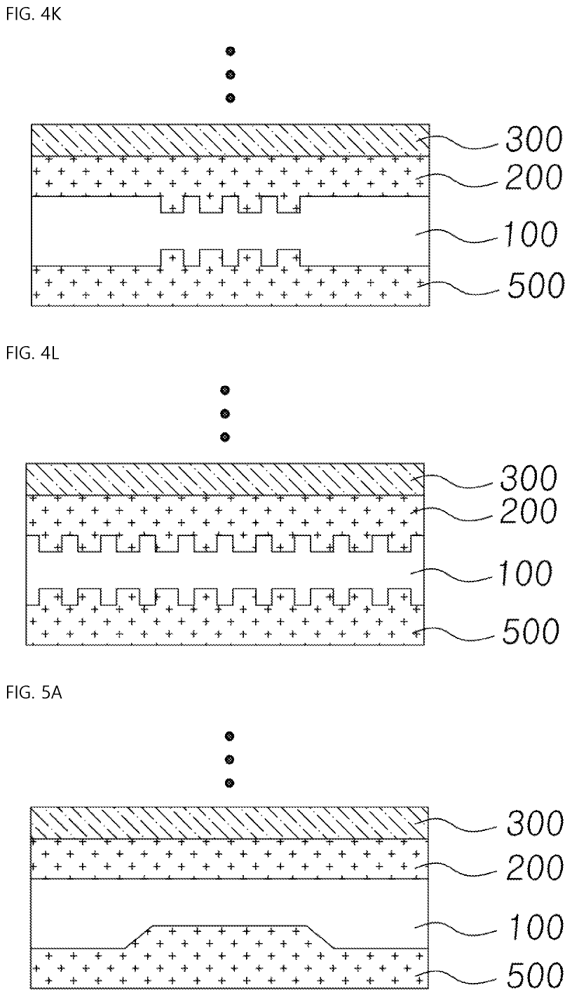

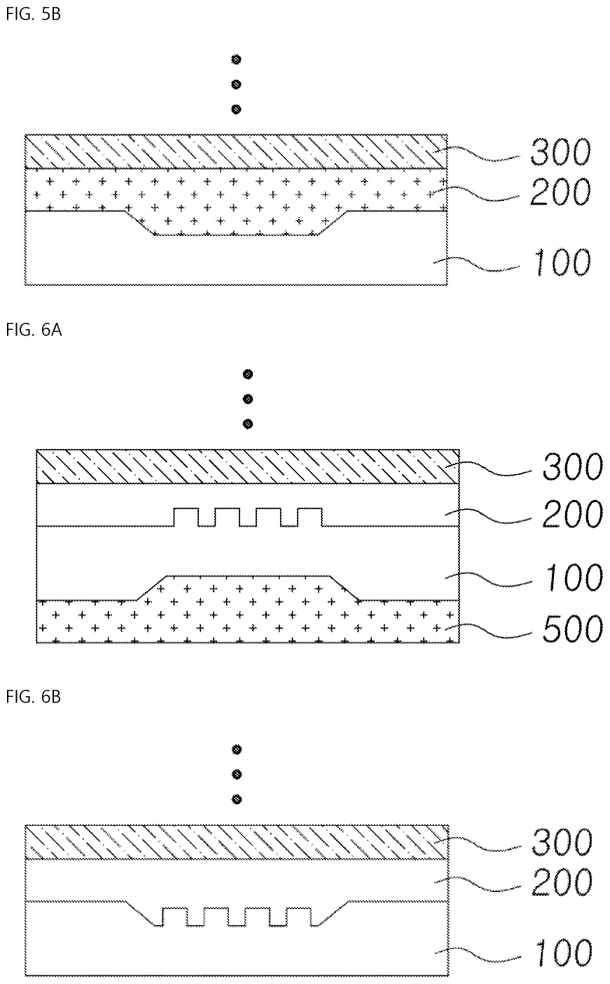

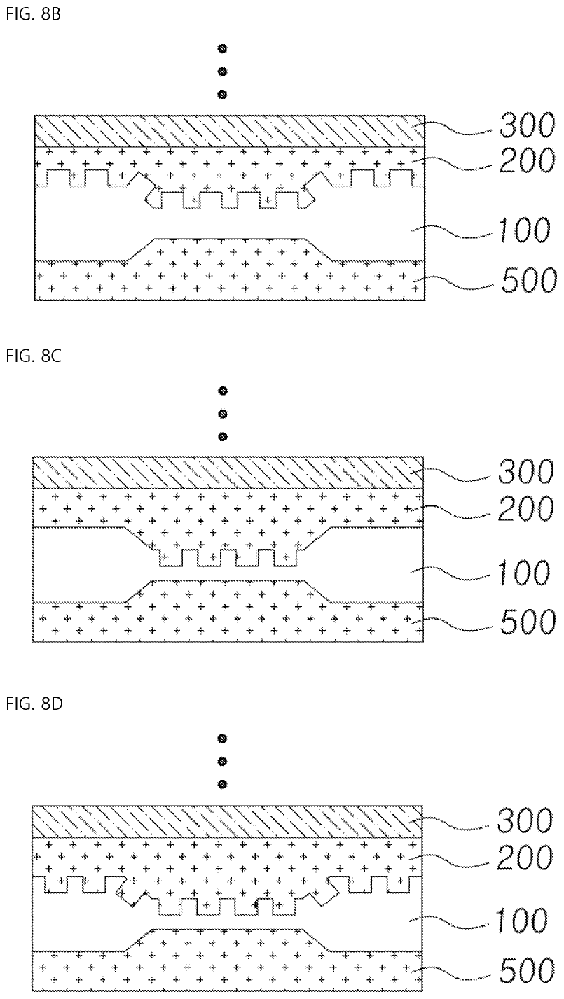

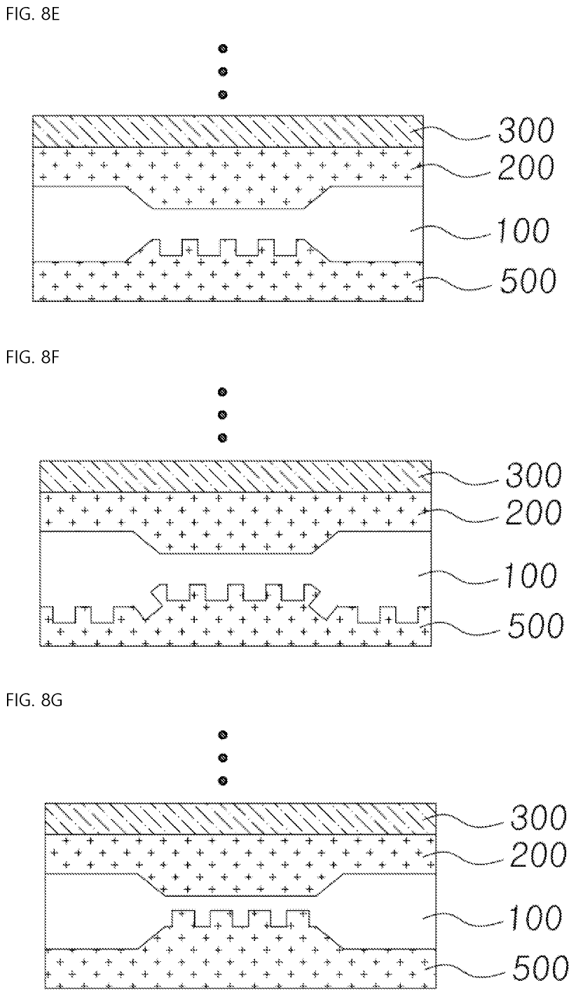

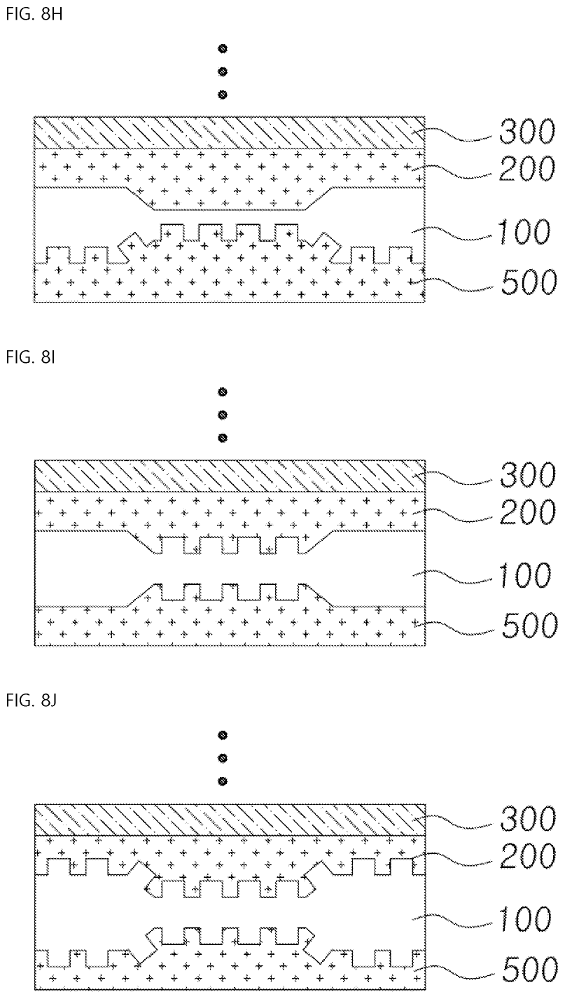

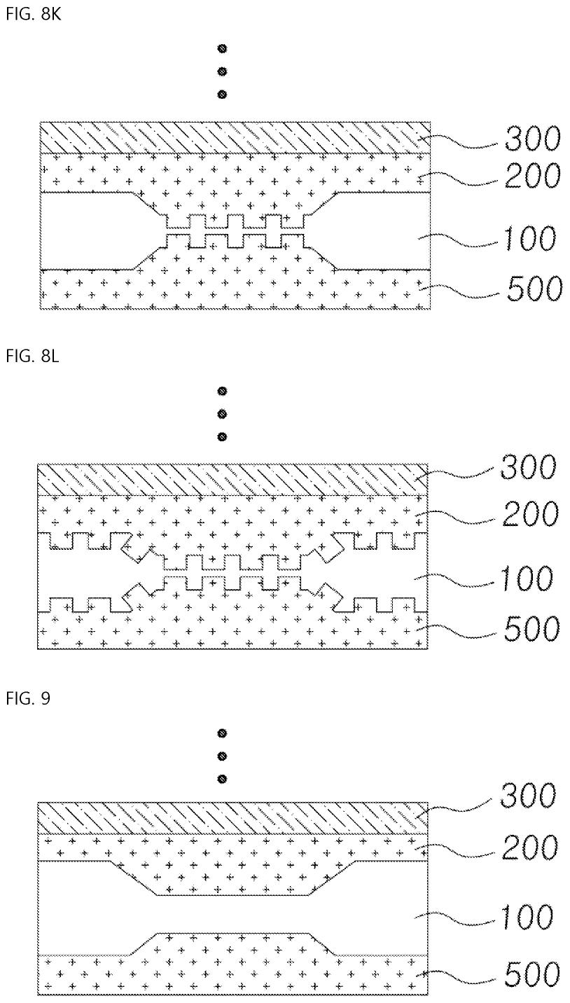

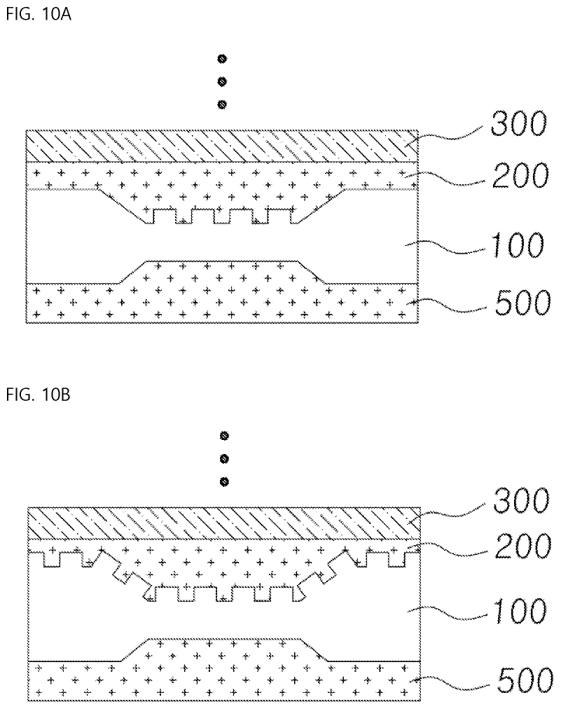

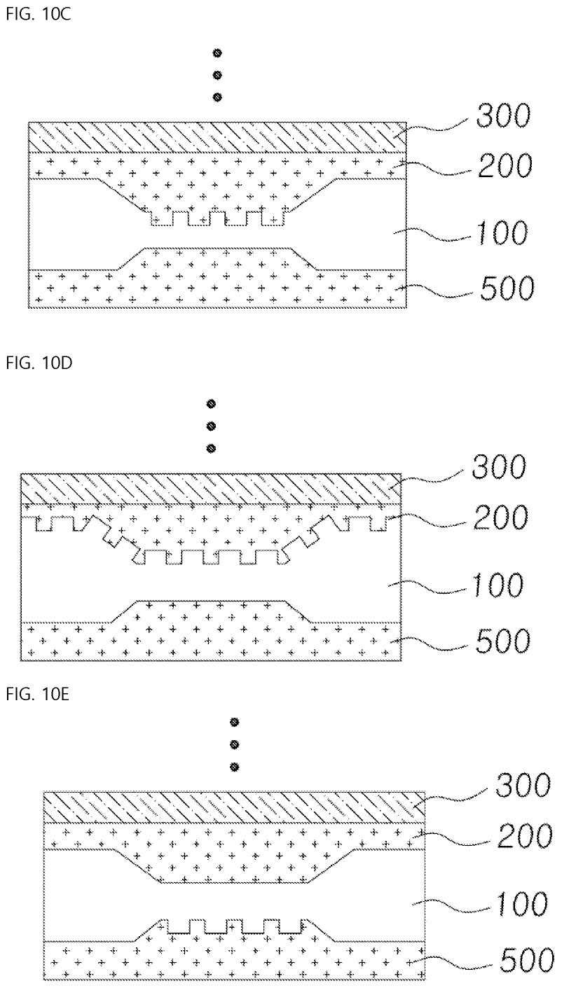

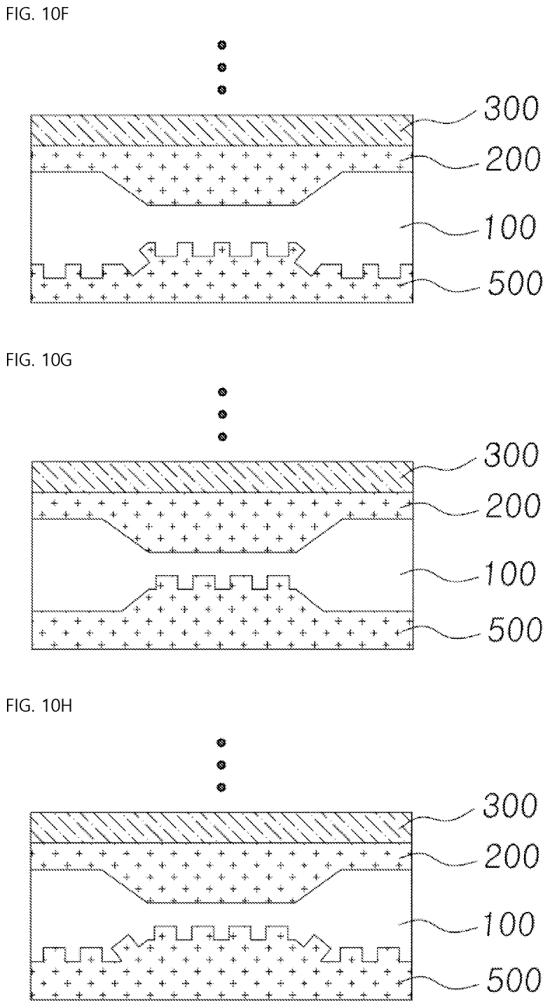

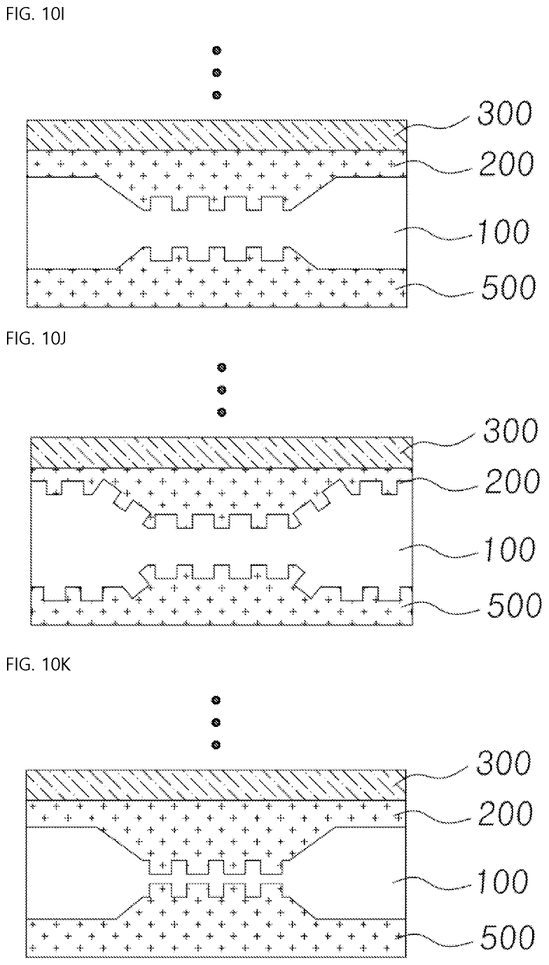

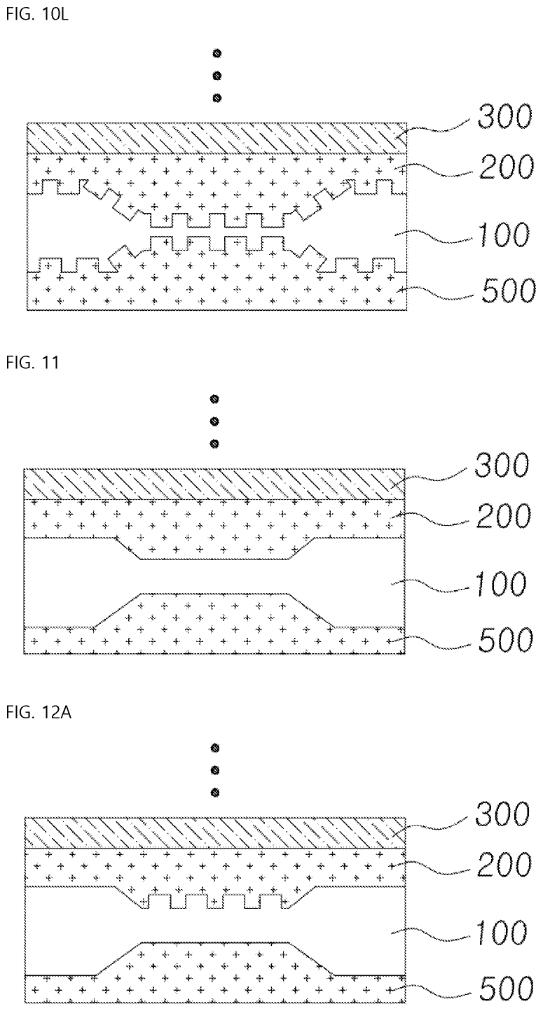

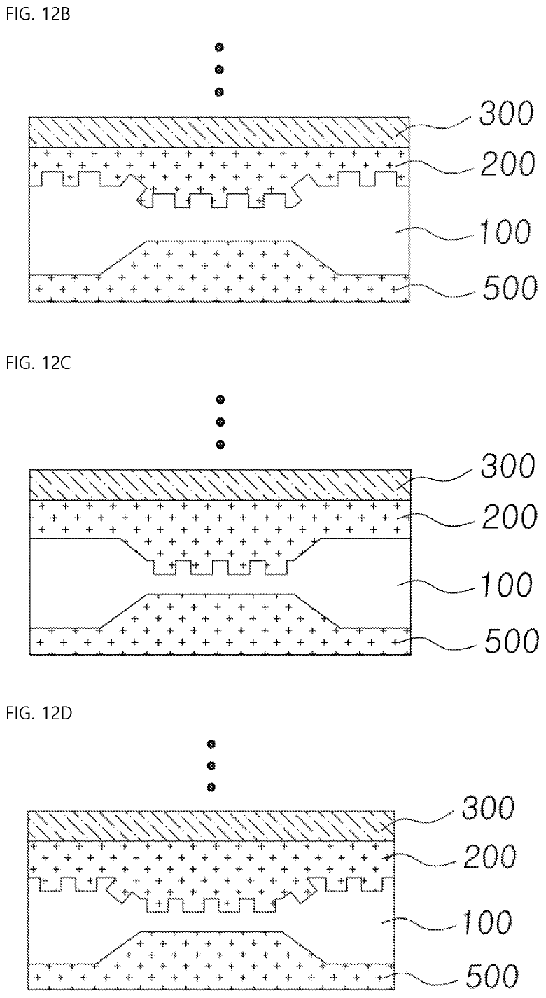

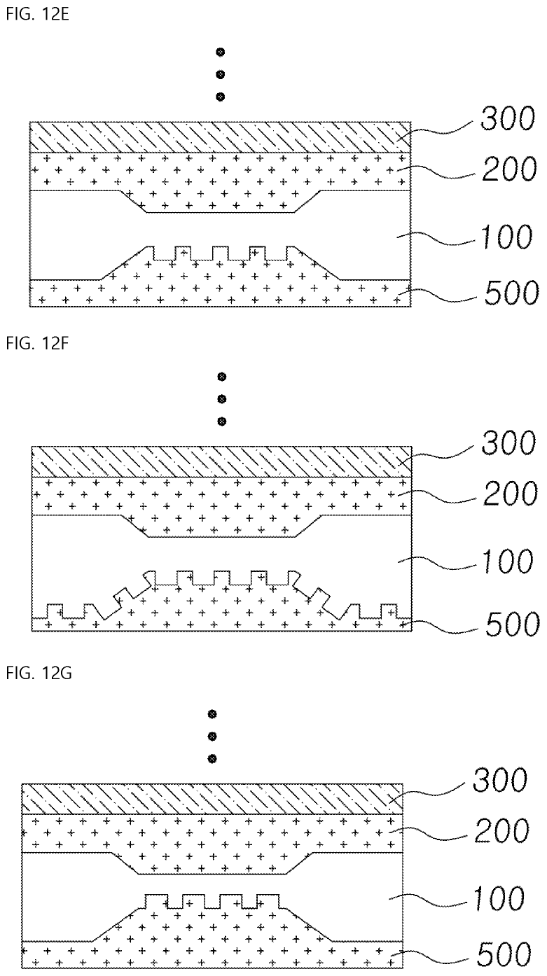

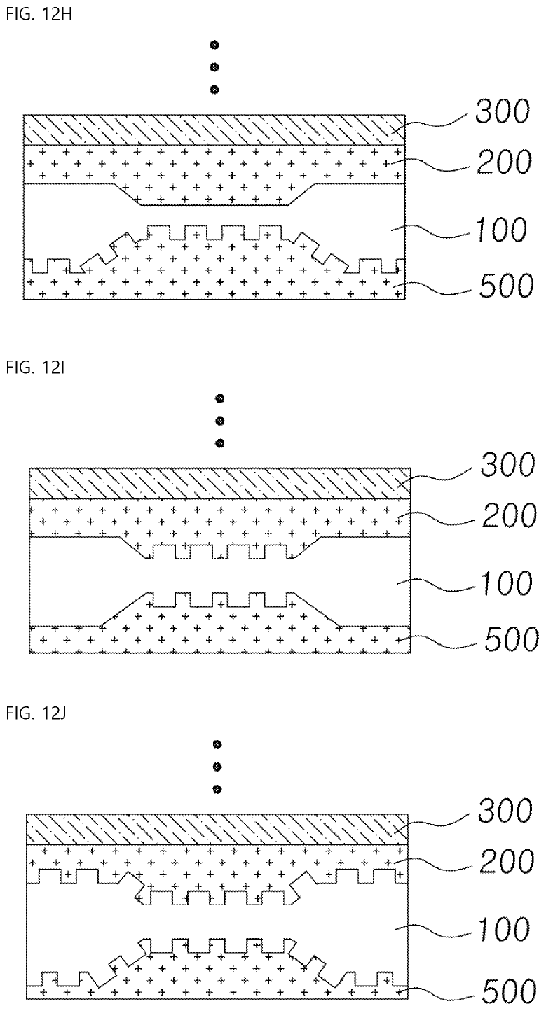

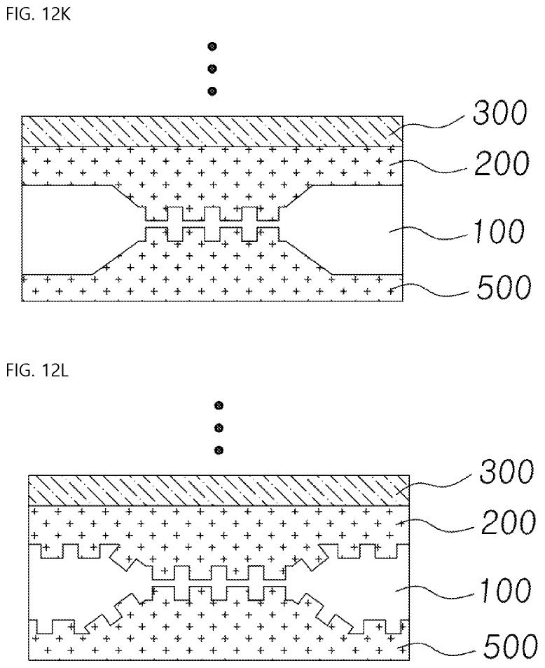

Hereinafter, the present invention will be described with reference to FIGS. 1A to 12L.

In the present invention, a folding region of a display is a region of the display at which the display is folded in two or a region of the display at which the display is bent or rolled. Also, in the present invention, a folding region of a cover window corresponding to the folding region of the display is referred to as a “folding portion” of the cover window, and a planar region of the cover window excluding the folding portion is referred to as a “planar portion” of the cover window.

In the present invention, a flat glass substrate means a glass substrate configured such that an embossed or engraved uneven pattern described herein is not formed on a glass surface, i.e., a glass substrate having a smooth surface.

In the present invention, a front surface means a surface that faces upwards in the drawings. In the present invention, a rear surface means a surface opposite the front surface, which is an opposite surface of touch, i.e., a surface in a direction toward a display panel, which is a surface that faces downwards in the drawings.

1. Even Structure

The present invention provides a glass-based flexible cover window with improved strength and surface hardness including a planar portion formed so as to correspond to a planar region of a flexible display and a folding portion formed so as to be connected to the planar portion, the folding portion being formed so as to correspond to a folding region of the flexible display, wherein the flexible cover window includes a flat glass substrate 100, an adhesive buffer layer 200 formed at a front surface of the glass substrate 100, a protective film layer 300 formed on the adhesive buffer layer 200, and a hard coating layer 400 formed on the protective film layer 300, and the adhesive buffer layer 200 and the protective film layer 300 are alternately stacked at least n times (where n is a natural number equal to or greater than 1).

In the flexible cover window according to the present invention, the adhesive buffer layer 200 and the protective film layer 300, which is joined to the adhesive buffer layer 200, are formed at least once, and the hard coating layer 400 is formed at the uppermost end. Consequently, aesthetics and tactile sensation inherent to glass are maintained, and high pen drop properties and puncture properties are exhibited, whereby it is possible to provide excellent strength and surface hardness.

In addition, the flexible cover window according to the present invention may be formed in the shape of a thin film using the flat glass substrate 100 and the predetermined protective film layer 300, whereby it is possible to provide excellent strength and surface hardness while satisfying folding properties.

1.1. Even Structure/One-Time Stackinq

FIGS. 1A to 1D are schematic views of flexible cover windows, each of which includes a flat glass substrate 100 and is configured such that an adhesive buffer layer 200 and a protective film layer 300 are alternately stacked once.

1.1.1. Even Structure/One-Time Stacking/Planar Portion and Folding Portion Having the Same Thickness

A flexible cover window according to an embodiment shown in FIG. 1A is flat and is configured such that a planar portion and a folding portion have the same thickness.

No embossed or engraved uneven pattern is formed on a glass substrate 100, whereby the surface of the glass substrate is smooth and flat.

At the glass substrate 100, the thickness of the planar portion and the thickness of the folding portion may be equal to each other.

No embossed or engraved uneven pattern is formed on the glass substrate 100, whereby the surface of the glass substrate is smooth and flat, and the thickness of the planar portion and the thickness of the folding portion may be equal to each other.

The thickness of the glass substrate 100, i.e., the thickness of each of the planar portion and the folding portion, may be 10 to 300 μm. If the thickness is less than 10 μm, strength and manufacturing processability may be reduced, which is undesirable. If the thickness exceeds 300 μm, the folding properties may be reduced, which is also undesirable. Specifically, the thickness of the glass substrate 100 may be 20 to 200 μm.

The flexible cover window shown in FIG. 1A is configured to have a structure in which the glass substrate 100, an adhesive buffer layer 200, a protective film layer 300, and a hard coating layer 400 are sequentially stacked.

The adhesive buffer layer 200 is formed at a front surface of the glass substrate 100, whereby the glass substrate 100 and the protective film layer 300 are adhered to each other. Deformation at the folding portion is minimized while an appropriate thickness and elasticity are maintained through the adhesive buffer layer 200, whereby impact resistance and durability may be improved.

The adhesive buffer layer 200 may include a transparent resin that has a refractive index approximately equal to the refractive index of glass to which the adhesive buffer layer is applied, such as an optically clear resin (OCR). Examples of the transparent resin may include, but are not limited to, acrylic, epoxy, silicone, urethane, a urethane composite, a urethane-acrylic composite, hybrid sol-gel, and siloxane.

The thickness of the adhesive buffer layer 200 may be appropriately adjusted within a range of 1 to 50 μm depending on the composition and thickness of the protective film layer 300. When adhesion is performed within the above range, deformation at the folding portion is minimized while an appropriate thickness and elasticity are maintained through the adhesive buffer layer 200, whereby impact resistance and durability may be improved.

The adhesive buffer layer 200 may have a strength of 0.01 to 1 GPa in order to minimize deformation at the interface upon impact, such as pen drop, while increasing the surface hardness and adhesion to the glass substrate 100 to improve overall durability.

The protective film layer 300 is formed on the adhesive buffer layer 200, and the thickness or physical properties of the protective film layer may be adjusted, whereby it is possible to prevent scratches on the cover window and to improve the impact resistance, strength, and folding properties at the same time.

The protective film layer 300 is not limited as long as the protective film layer is made of a transparent rigid resin. For example, the protective film layer 300 may be made of at least one selected from the group consisting of polyethylene terephthalate (PET), transparent polyimide (TPI), polyurethane (PU), polypropylene (PP), polyethylene naphthalate (PEN), and polycarbonate (PC). Specifically, the protective film layer 300 may be made of PET or TPI, which has excellent transparency and flexibility. More specifically, the protective film layer 300 may be made of TPI, which has excellent heat resistance, chemical resistance, and durability, whereby it is possible to maintain inherent aesthetics of glass and to have an appropriate thickness to ensure strength while minimizing loosening or buckling problems that leave marks at the folding region after repeated folding. In particular, TPI has a surface hardness of about 5 to 6H when used simultaneously with the hard coating layer 400, which will be described below, and therefore TPI may also have excellent surface hardness properties, compared to PET, which has a surface hardness of 3 to 4H.

The strength of the protective film layer 300 at the planar portion and the strength of the protective film layer 300 at the folding portion may be equal to or different from each other.

The thickness of the protective film layer 300 may be 1 to 100 μm. Within the above thickness range, a surface hardness of 3H to 6H may be secured while the texture and tactile sensation inherent to glass are maintained, whereby strength may be increased while being thin, and folding properties may also be satisfied. If the thickness exceeds 100 μm, which is beyond the above range, the thickness of the cover window increases, and therefore the intended effect of the present invention may not be obtained, which is undesirable. If the thickness is less than 1 μm, processability may be reduced and the desired impact resistance may not be obtained, which is also undesirable. Specifically, the thickness of the protective film layer 300 may be 1 to 50 μm, more specifically 10 to 50 μm.

The hard coating layer 400 is formed on the protective film layer 300 such that impact force, such as pen drop, is supported and dispersed, thereby contributing to improvement of impact resistance to pen drop and puncture, improvement of folding properties, and increase in strength and surface hardness.

The hard coating layer (H/C) 400 may be formed by applying, for example, an acrylic resin, an epoxy resin, or a siloxane resin, which exhibits relatively high hardness when hardened. An anti-fingerprint (AF) or anti-reflective (AR) function may be imparted to the hard coating layer 400 as needed. For example, the anti-fingerprint (AF) or the anti-reflective (AR) function may be implemented by synthesizing a resin having such a function or by forming various patterns.

The thickness of the hard coating layer 400 may be 1 to 30 μm. If the thickness of the hard coating layer 400 is less than 1 μm, which deviates from the above range, it is difficult to achieve the impact force support and dispersion effect, which is undesirable. If the thickness of the hard coating layer 400 exceeds 30 μm, the thickness of the cover window increases and it is difficult to achieve the effect as a thin plate, which is also undesirable.

Referring to FIG. 1B showing an embodiment, depending on circumstances, an elastic buffer layer 500 may be optionally formed on a rear surface of the glass substrate 100 to minimize deformation at the folding portion while maintaining an appropriate thickness and elasticity, whereby it is possible to improve impact resistance and durability.

The elastic buffer layer 500 may include a transparent resin that has a refractive index approximately equal to the refractive index of glass to which the elastic buffer layer is applied, such as an optically clear resin (OCR). Examples of the transparent resin may include, but are not limited to, acrylic, epoxy, silicone, urethane, a urethane composite, a urethane-acrylic composite, hybrid sol-gel, and siloxane.

The elastic buffer layer 500 may have a strength of 0.01 to 1 GPa in order to minimize deformation at the interface upon impact, such as pen drop, while increasing the surface hardness and adhesion to the glass substrate 100 to improve overall durability.

The thickness of the elastic buffer layer 500 may be appropriately adjusted within a range of 1 to 50 μm depending on the composition and thickness of the elastic buffer layer 500. When adhesion is performed within the above range, deformation at the folding portion is minimized while an appropriate thickness and elasticity are maintained through the elastic buffer layer 500, whereby impact resistance and durability may be improved.

When no uneven pattern is formed at the rear surface of the glass substrate or when no inclined portion is formed at the rear surface of the glass substrate, however, the elastic buffer layer 500 is not preferably formed on the rear surface of the glass substrate such that the glass substrate is formed in the shape of a thin film in order to improve folding properties thereof.

1.1.2. Even Structure/One-Time Stacking/Planar Portion and Folding Portion Having Different Thicknesses

A flexible cover window according to an embodiment shown in FIG. 1C is flat and is configured such that an inclined portion is located at a rear surface, whereby a planar portion and a folding portion have different thicknesses.

No embossed or engraved uneven pattern is formed on a glass substrate 100, whereby the surface of the glass substrate is smooth and flat.

At least one surface of the folding portion of the glass substrate 100 includes an inclined portion, whereby the thickness of the folding portion may be less than the thickness of the planar portion.

No embossed or engraved uneven pattern is formed on the glass substrate 100, whereby the surface of the glass substrate is smooth and flat, and at least one surface of the folding portion of the glass substrate 100 includes an inclined portion, whereby the thickness of the folding portion may be less than the thickness of the planar portion.

The shape of the inclined portion formed at the folding portion of the glass substrate 100 is not limited as long as the inclined portion is formed so as to be concave from an outer surface of the folding portion in a thickness direction. For example, the inclined portion may have a shape that extends in a straight or curved line such that the thickness of the folding portion increases from a middle planar part of the glass toward an edge part of the glass. However, the shape of the inclined portion may also include, broadly speaking, the shape in which the middle planar part of the glass and the edge part of the glass extend perpendicular to each other.

In connection therewith, the inclined portion of the glass shown in FIG. 1C is a forward type inclined portion in which the inclined portion is formed at a rear surface so as to have a shape extending in a straight line such that the thickness of the folding portion increases from the middle planar part in a direction toward the edge part.

The inclined portion formed at the folding portion of the glass substrate 100 may be located at a rear surface, a front surface, or both surfaces. Specifically, when the inclined portion is formed at the rear surface of the glass substrate 100, the inclined portion may be a forward type inclined portion. When the inclined portion is formed at the front surface of the glass substrate 100, the inclined portion may be a reverse type inclined portion, which is a reversal of the forward type inclined portion. When the inclined portion is formed at the front surface and the rear surface of the glass substrate 100, the inclined portion may be a double-sided type inclined portion.

The depth h₂ of the inclined portion formed at the folding portion of the glass substrate 100 may be appropriately selected depending on the thickness h₁ of the glass substrate 100. For example, in the forward type inclined portion or the reverse type inclined portion, the depth of the inclined portion may be 5 to 70%, specifically 10 to 50%, more specifically 15 to 40%, of the thickness of the glass, i.e., the thickness of the planar portion. In the double-sided type inclined portion, the depth of the inclined portion may be 5 to 35%, specifically 10 to 30%, of the thickness of the glass, i.e., the thickness of the planar portion.

If the depth of the inclined portion formed at the folding portion is too large, which deviates from the above range, the thickness of the folding portion is too small, in which case, folding performance is good, but strength may be reduced and wrinkles may be easily generated, which is undesirable. If the depth of the inclined portion is too small, the thickness of the folding portion is too large, in which case, flexibility, resilience, and elasticity are reduced at the time of folding, resulting in poor folding performance, which is also undesirable.

In the reverse type inclined portion, in which the inclined portion is formed at the front surface of the glass substrate 100, an adhesive buffer layer 200 is formed thicker at the folding portion than in the forward type inclined portion, in which the inclined portion is formed at the rear surface of the glass substrate 100, to induce shock absorption, whereby pen drop properties and impact resistance may be excellent.

In the double-sided type inclined portion, in which the inclined portion is formed at the front surface and the rear surface of the glass substrate 100, the depth of the inclined portion at the front surface (the depth of a front part) and the depth of the inclined portion at the rear surface (the depth of a rear part) may be equal to or different from each other. Specifically, in the double-sided type inclined portion, the depth of the front part may be equal to the depth of the rear part, the depth of the front part may be greater than the depth of the rear part, or the depth of the front part may be less than the depth of the rear part.

At the glass substrate 100, the thickness of the folding portion may be 5 to 100 μm, and the thickness of the planar portion may be 10 to 300 μm. If the thickness of the folding portion is less than 5 μm or the thickness of the planar portion is less than 10 μm, strength and manufacturing processability may be reduced, which is undesirable. If the thickness of the folding portion exceeds 100 μm or the thickness of the planar portion exceeds 300 μm, the folding properties may be reduced, which is also undesirable. Specifically, the thickness of the folding portion may be 10 to 80 μm, and the thickness of the planar portion may be 50 to 200 μm.

The glass substrate 100 may be made of chemically tempered glass.

The flexible cover window shown in FIG. 1C is configured to have a structure in which the glass substrate 100, the adhesive buffer layer 200, a protective film layer 300, and a hard coating layer 400 are sequentially stacked. The adhesive buffer layer 200, the protective film layer 300, and the hard coating layer 400 may have the same shapes as previously described.

Referring to FIG. 1D showing an embodiment, depending on circumstances, an elastic buffer layer 500 may be optionally formed on the rear surface of the glass substrate 100 to minimize deformation at the folding portion while maintaining an appropriate thickness and elasticity, whereby it is possible to improve impact resistance and durability.

When an uneven pattern is formed at the rear surface of the glass substrate or when an inclined portion is formed at the rear surface of the glass substrate, the elastic buffer layer 500 is preferably formed on the rear surface of the glass substrate in order to improve impact resistance and durability and to protect the uneven pattern and the inclined portion.

The elastic buffer layer 500 may have the same shape as previously described.

1.2. Even Structure/(n+1)-Time Stacking

FIGS. 1E and 1F are schematic views of flexible cover windows, each of which includes a flat glass substrate 100 and is configured such that an adhesive buffer layer 200 and a protective film layer 300 are alternately stacked twice.

The flexible cover window according to the present invention is configured such that the adhesive buffer layer 200 and the protective film layer 300 are alternately stacked at least n+1 times (where n is a natural number equal to or greater than 1), whereby rigidity against pen drop and puncture is increased while aesthetics and tactile sensation inherent to glass are maintained, and therefore it is possible to secure excellent strength and surface hardness.

1.2.1. Even Structure/(n+1)-Time Stacking/Planar Portion and Folding Portion Having the Same Thickness

A flexible cover window according to an embodiment shown in FIG. 1E is flat and is configured such that a planar portion and a folding portion have the same thickness.

No embossed or engraved uneven pattern is formed on a glass substrate 100, whereby the surface of the glass substrate is smooth and flat.

At the glass substrate 100, the thickness of the planar portion and the thickness of the folding portion may be equal to each other.

No embossed or engraved uneven pattern is formed on the glass substrate 100, whereby the surface of the glass substrate is smooth and flat, and the thickness of the planar portion and the thickness of the folding portion may be equal to each other.

The thickness of the glass substrate 100, i.e., the thickness of each of the planar portion and the folding portion, may be 10 to 300 μm. If the thickness is less than 10 μm, strength and manufacturing processability may be reduced, which is undesirable. If the thickness exceeds 300 μm, the folding properties may be reduced, which is also undesirable. Specifically, the thickness of the glass substrate 100 may be 20 to 200 μm.

An adhesive buffer layer 200 is formed at a front surface of the glass substrate 100, whereby the glass substrate 100 and the protective film layer 300 are adhered to each other. Deformation at the folding portion is minimized while an appropriate thickness and elasticity are maintained through the adhesive buffer layer 200, whereby impact resistance and durability may be improved.

The flexible cover window shown in FIG. 1E is configured to have a structure in which the glass substrate 100, a first adhesive buffer layer 200, a first protective film layer 300, a second adhesive buffer layer 210, a second protective film layer 310, and a hard coating layer 400 are sequentially stacked.

When the adhesive buffer layer and the protective film layer are alternately stacked at least n+1 times in a stacking direction, the compositions of n-th and (n+1)-th adhesive buffer layers may be identical to or different from each other, and the compositions of n-th and (n+1)-th protective film layers may be identical to or different from each other (where n is a natural number equal to or greater than 1). It is possible to secure the folding properties while implementing appropriate strength by adjusting the compositions of the alternately stacked layers.

Each of the first adhesive buffer layer 200 and the second adhesive buffer layer 210 may include a transparent resin that has a refractive index approximately equal to the refractive index of glass to which each adhesive buffer layer is applied, such as an optically clear resin (OCR). Examples of the transparent resin may include, but are not limited to, acrylic, epoxy, silicone, urethane, a urethane composite, a urethane-acrylic composite, hybrid sol-gel, and siloxane.

In an embodiment, the first adhesive buffer layer 200 may be made of an OCR, and the second adhesive buffer layer 210 may be made of an OCR.

The first protective film layer 300 or the second protective film layer 310 is not limited as long as the protective film layer is made of a transparent rigid resin. For example, the first protective film layer 300 or the second protective film layer 310 may be made of at least one selected from the group consisting of polyethylene terephthalate (PET), transparent polyimide (TPI), polyurethane (PU), polypropylene (PP), polyethylene naphthalate (PEN), and polycarbonate (PC). Specifically, the first protective film layer 300 or the second protective film layer 310 may be made of PET or TPI, which has excellent transparency and flexibility. More specifically, the first protective film layer 300 or the second protective film layer 310 may be made of TPI, which has excellent heat resistance, chemical resistance, and durability, whereby it is possible to maintain inherent aesthetics of glass and to have an appropriate thickness to ensure strength while minimizing loosening or buckling problems that leave marks at the folding region after repeated folding. In particular, TPI has a surface hardness of about 5 to 6H when used simultaneously with the hard coating layer 400, which will be described below, and therefore TPI may also have excellent surface hardness properties, compared to PET, which has a surface hardness of 3 to 4H.

In an embodiment, the first protective film layer 300 may be made of PET, and the second protective film layer 310 may be made of PET. In another embodiment, the first protective film layer 300 may be made of PET, and the second protective film layer 310 may be made of TPI. In a further embodiment, the first protective film layer 310 may be made of TPI, and the second protective film layer 320 may be made of TPI. However, if the first protective film layer is made of TPI and the second protective film layer is made of PET, i.e., if different types of protective film layers are used and TPI is formed inside the window, the difference in modulus between TPI and PET increases, whereby the degree of stretching or deformation increases depending on external conditions, causing a loss of strength, which is undesirable.

When the adhesive buffer layer 200 and the protective film layer 300 are alternately stacked at least n+1 times in a stacking direction, the thickness of an n-th adhesive buffer layer 200 may be less than the thickness of an (n+1)-th adhesive buffer layer 210, and the thickness of an n-th protective film layer 300 may be less than the thickness of an (n+1)-th protective film layer 310 (where n is a natural number equal to or greater than 1). It is possible to secure the folding properties while implementing appropriate strength by adjusting the thicknesses of the alternately stacked layers.

The thickness of the first adhesive buffer layer 200 or the second adhesive buffer layer 210 may be appropriately adjusted within a range of 1 to 50 μm depending on the composition and thickness of the protective film layer. When adhesion is performed within the above range, deformation at the folding portion is minimized while an appropriate thickness and elasticity are maintained through the adhesive buffer layer, whereby impact resistance and durability may be improved.

In an embodiment, the thickness of the first adhesive buffer layer 200 may be less than the thickness of the second adhesive buffer layer 210 within the above thickness range.

The thickness of the first protective film layer 300 or the second protective film layer 310 may be 1 to 100 μm. Within the above thickness range, a surface hardness of 3H to 6H may be secured while the texture and tactile sensation inherent to glass are maintained, whereby strength may be increased while being thin, and folding properties may also be satisfied. If the thickness exceeds 100 μm, which is beyond the above range, the thickness of the cover window increases, and therefore the intended effect of the present invention may not be obtained, which is undesirable. If the thickness is less than 1 μm, processability may be reduced and the desired impact resistance may not be obtained, which is also undesirable. Specifically, the thickness of the first protective film layer 300 or the second protective film layer 310 may be 1 to 50 μm, more specifically 10 to 50 μm.

In an embodiment, the thickness of the first protective film layer 300 may be less than the thickness of the second protective film layer 310 within the above thickness range.

The hard coating layer 400 is formed on the second protective film layer 310 such that impact force, such as pen drop, is supported and dispersed, thereby contributing to improvement of impact resistance to pen drop and puncture, improvement of folding properties, and increase in strength and surface hardness.

The hard coating layer (H/C) 400 may be formed by applying, for example, an acrylic resin, an epoxy resin, or a siloxane resin, which exhibits relatively high hardness when hardened. An anti-fingerprint (AF) or anti-reflective (AR) function may be imparted to the hard coating layer 400 as needed. For example, the anti-fingerprint (AF) or the anti-reflective (AR) function may be implemented by synthesizing a resin having such a function or by forming various patterns at the functional layer.

The thickness of the hard coating layer 400 may be 1 to 30 μm. If the thickness of the hard coating layer 400 is less than 1 μm, which deviates from the above range, it is difficult to achieve the impact force support and dispersion effect, which is undesirable. If the thickness of the hard coating layer 400 exceeds 30 μm, the thickness of the cover window increases and it is difficult to achieve the effect as a thin plate, which is also undesirable.

Referring to FIG. 1F showing an embodiment, depending on circumstances, an elastic buffer layer 500 may be optionally formed on a rear surface of the glass substrate 100 to minimize deformation at the folding portion while maintaining an appropriate thickness and elasticity, whereby it is possible to improve impact resistance and durability.

The elastic buffer layer 500 may include a transparent resin that has a refractive index approximately equal to the refractive index of glass to which the elastic buffer layer is applied, such as an optically clear resin (OCR). Examples of the transparent resin may include, but are not limited to, acrylic, epoxy, silicone, urethane, a urethane composite, a urethane-acrylic composite, hybrid sol-gel, and siloxane.

The elastic buffer layer 500 may have a strength of 0.01 to 1 GPa in order to minimize deformation at the interface upon impact, such as pen drop, while increasing the surface hardness and adhesion to the glass substrate 100 to improve overall durability.

The thickness of the elastic buffer layer 500 may be appropriately adjusted within a range of 1 to 50 μm depending on the composition and thickness of the elastic buffer layer 500. When adhesion is performed within the above range, deformation at the folding portion is minimized while an appropriate thickness and elasticity are maintained through the elastic buffer layer 500, whereby impact resistance and durability may be improved.

When no uneven pattern is formed at the rear surface of the glass substrate or when no inclined portion is formed at the rear surface of the glass substrate, however, the elastic buffer layer 500 is not preferably formed on the rear surface of the glass substrate such that the glass substrate is formed in the shape of a thin film in order to improve folding properties thereof.

1.2.2. Even Structure/(n+1)-Time Stacking/Planar Portion and Folding Portion Having Different Thicknesses

A flexible cover window according to an embodiment shown in FIG. 1G is flat and is configured such that an inclined portion is located at a rear surface, whereby a planar portion and a folding portion have different thicknesses.

No embossed or engraved uneven pattern is formed on a glass substrate 100, whereby the surface of the glass substrate is smooth and flat.

At least one surface of the folding portion of the glass substrate 100 includes an inclined portion, whereby the thickness of the folding portion may be less than the thickness of the planar portion.

No embossed or engraved uneven pattern is formed on a glass substrate 100, whereby the surface of the glass substrate is smooth and flat, and at least one surface of the folding portion includes an inclined portion, whereby the thickness of the folding portion may be less than the thickness of the planar portion.

The shape of the inclined portion formed at the folding portion of the glass substrate 100 is not limited as long as the inclined portion is formed so as to be concave from an outer surface of the folding portion in a thickness direction. For example, the inclined portion may have a shape that extends in a straight or curved line such that the thickness of the folding portion increases from a middle planar part of the glass toward an edge part of the glass. However, the shape of the inclined portion may also include, broadly speaking, the shape in which the middle planar part of the glass and the edge part of the glass extend perpendicular to each other.

In connection therewith, the inclined portion of the glass shown in FIG. 1G extends in a straight line such that the thickness of the folding portion increases from the middle planar part in a direction toward the edge part.

The inclined portion formed at the folding portion of the glass substrate 100 may be located at a rear surface, a front surface, or both surfaces. Specifically, when the inclined portion is formed at the rear surface of the glass substrate 100, the inclined portion may be a forward type inclined portion. When the inclined portion is formed at the front surface of the glass substrate 100, the inclined portion may be a reverse type inclined portion, which is a reversal of the forward type inclined portion. When the inclined portion is formed at the front surface and the rear surface of the glass substrate 100, the inclined portion may be a double-sided type inclined portion.

The depth h₂ of the inclined portion formed at the folding portion of the glass substrate 100 may be appropriately selected depending on the thickness h₁ of the glass substrate 100. For example, in the forward type inclined portion or the reverse type inclined portion, the depth of the inclined portion may be 5 to 70%, specifically 10 to 50%, more specifically 15 to 40%, of the thickness of the glass, i.e., the thickness of the planar portion. In the double-sided type inclined portion, the depth of the inclined portion may be 5 to 35%, specifically 10 to 30%, of the thickness of the glass, i.e., the thickness of the planar portion.

If the depth of the inclined portion formed at the folding portion is too large, which deviates from the above range, the thickness of the folding portion is too small, in which case, folding performance is good, but strength may be reduced and wrinkles may be easily generated, which is undesirable. If the depth of the inclined portion is too small, the thickness of the folding portion is too large, in which case, flexibility, resilience, and elasticity are reduced at the time of folding, resulting in poor folding performance, which is also undesirable.

In the reverse type inclined portion, in which the inclined portion is formed at the front surface of the glass substrate 100, an adhesive buffer layer 200 is formed thicker at the folding portion than in the forward type inclined portion, in which the inclined portion is formed at the rear surface of the glass substrate 100, to induce shock absorption, whereby pen drop properties and impact resistance may be excellent.

In the double-sided type inclined portion, in which the inclined portion is formed at the front surface and the rear surface of the glass substrate 100, the depth of the inclined portion at the front surface (the depth of a front part) and the depth of the inclined portion at the rear surface (the depth of a rear part) may be equal to or different from each other. Specifically, in the double-sided type inclined portion, the depth of the front part may be equal to the depth of the rear part, the depth of the front part may be greater than the depth of the rear part, or the depth of the front part may be less than the depth of the rear part.

The thickness of the glass substrate 100, i.e., the thickness of each of the planar portion and the folding portion, may be 10 to 300 μm. If the thickness is less than 10 μm, strength and manufacturing processability may be reduced, which is undesirable. If the thickness exceeds 300 μm, the folding properties may be reduced, which is also undesirable. Specifically, the thickness of the glass substrate 100 may be 20 to 200 μm.

The glass substrate 100 may be made of chemically tempered glass.

The flexible cover window shown in FIG. 1G is configured to have a structure in which the glass substrate 100, a first adhesive buffer layer 200, a first protective film layer 300, a second adhesive buffer layer 210, a second protective film layer 310, and a hard coating layer 400 are sequentially stacked. The first adhesive buffer layer 200, the first protective film layer 300, the second adhesive buffer layer 210, the second protective film layer 310, and the hard coating layer 400 may have the same shapes as previously described.

The adhesive buffer layer 200 is formed on the front surface of the glass substrate 100, whereby the glass substrate 100 and the protective film layer 300 are adhered to each other. Deformation at the folding portion is minimized while an appropriate thickness and elasticity are maintained through the adhesive buffer layer 200, whereby impact resistance and durability may be improved.

Referring to FIG. 1H showing an embodiment, depending on circumstances, an elastic buffer layer 500 may be optionally formed on the rear surface of the glass substrate 100 to minimize deformation at the folding portion while maintaining an appropriate thickness and elasticity, whereby it is possible to improve impact resistance and durability.

The elastic buffer layer 500 may have the same shape as previously described.

When an uneven pattern is formed at the rear surface of the glass substrate or when an inclined portion is formed at the rear surface of the glass substrate, the elastic buffer layer 500 is preferably formed on the rear surface of the glass substrate in order to improve impact resistance and durability and to protect the uneven pattern and the inclined portion.

2. Uneven Structure

Meanwhile, the present invention provides a glass-based flexible cover window with improved strength and surface hardness including a planar portion formed so as to correspond to a planar region of a flexible display and a folding portion formed so as to be connected to the planar portion, the folding portion being formed so as to correspond to a folding region of the flexible display, wherein the flexible cover window includes a glass substrate 100 having an embossed or engraved uneven pattern formed thereat, an adhesive buffer layer 200 formed at a front surface of the glass substrate 100, a protective film layer 300 formed on the adhesive buffer layer 200, and a hard coating layer 400 formed on the protective film layer 300, and the adhesive buffer layer 200 and the protective film layer 300 are alternately stacked at least n times (where n is a natural number equal to or greater than 1).

In the flexible cover window according to the present invention, the adhesive buffer layer 200 and the protective film layer 300, which is joined to the adhesive buffer layer 200, are formed at least once, and the hard coating layer 400 is formed at the uppermost end. Consequently, aesthetics and tactile sensation inherent to glass are maintained, and high pen drop properties and puncture properties are exhibited, whereby it is possible to provide excellent strength and surface hardness.

In addition, the flexible cover window according to the present invention may be formed in the shape of a thin film using the predetermined protective film layer 300, whereby it is possible to provide excellent strength and surface hardness while satisfying folding properties.

Furthermore, in the flexible cover window according to the present invention, rigidity against pen drop increased using the glass substrate 100 having the embossed or engraved uneven pattern formed thereat, whereby it is possible to provide excellent strength and surface hardness while satisfying folding properties. Since impact is efficiently dispersed or absorbed by the uneven pattern, impact resistance is improved, and screen distortion or resolution degradation is minimized, whereby it is possible to provide a high-quality flexible cover window.

2.1. Uneven Structure/One-Time Stacking

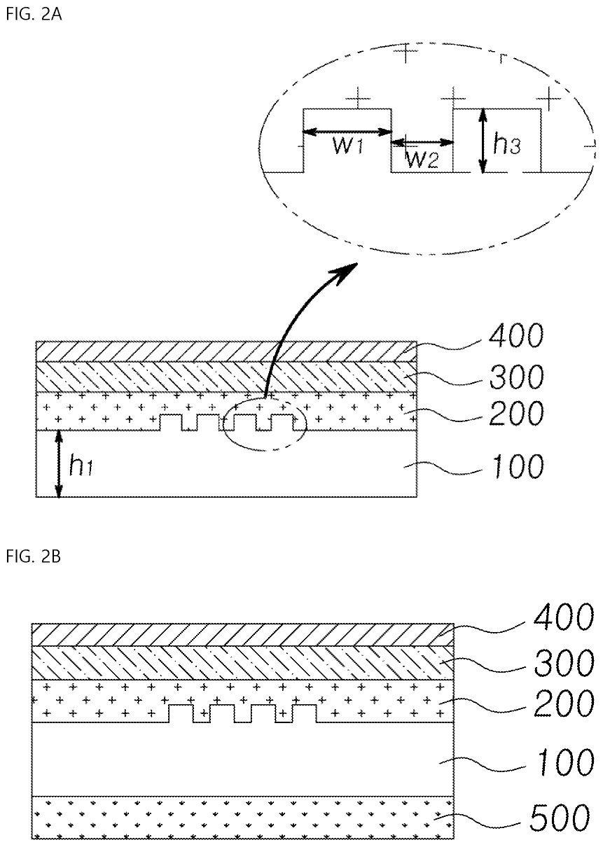

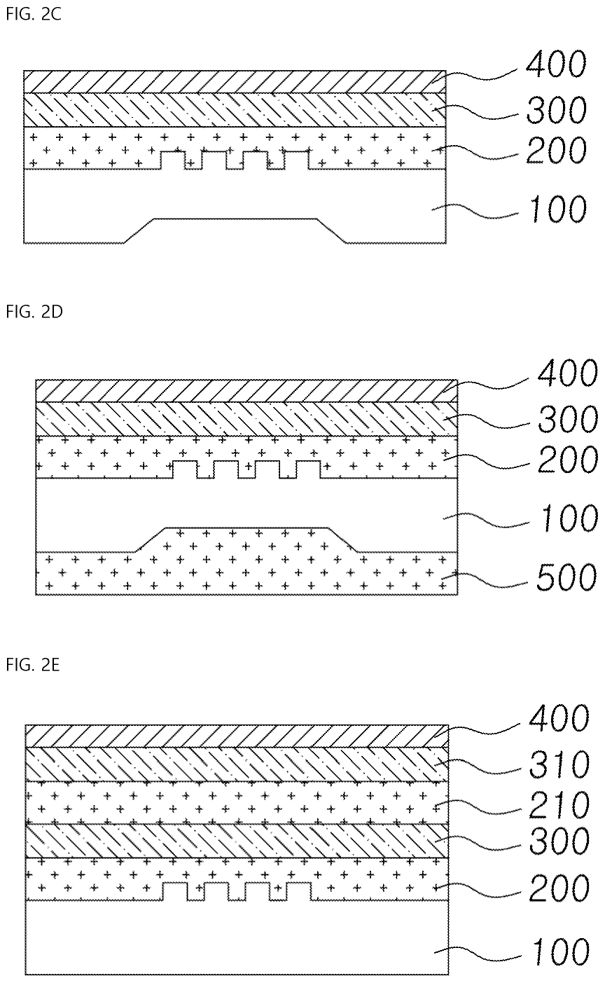

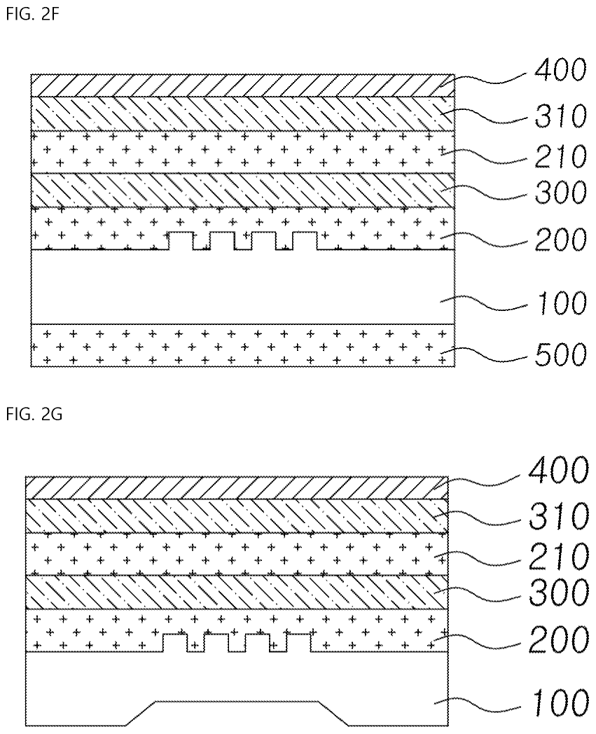

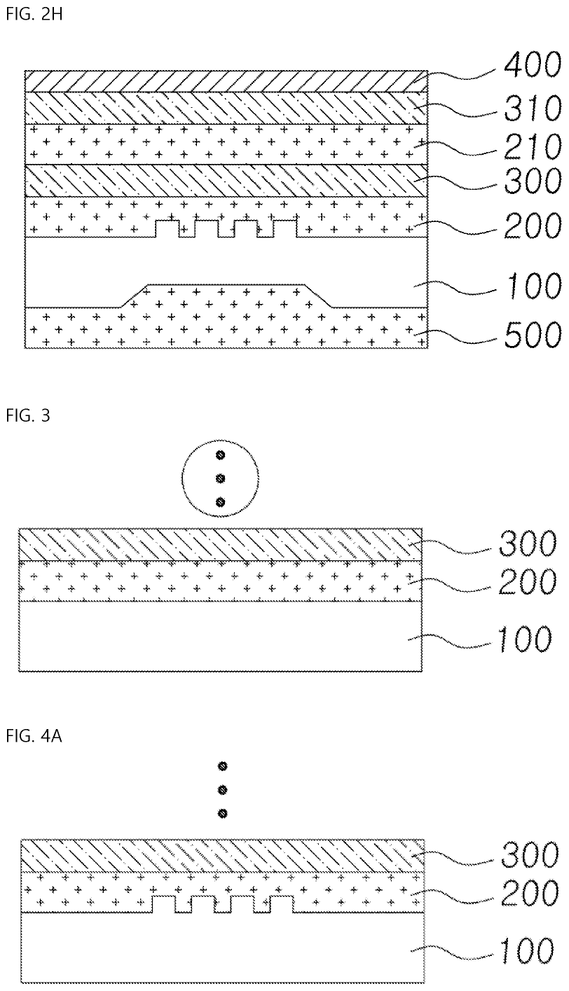

FIGS. 2A to 2D are schematic views of flexible cover windows, each of which includes a glass substrate 100 having an embossed uneven pattern formed thereat and is configured such that an adhesive buffer layer 200 and a protective film layer 300 are alternately stacked once.

2.1.1. Uneven Structure/One-Time Stacking/Planar Portion and Folding Portion Having the Same Thickness

A flexible cover window according to an embodiment shown in FIG. 2A is configured such that an embossed uneven pattern is located at a front surface of a folding portion of a glass substrate 100 and such that a planar portion and the folding portion have the same thickness.

The embossed uneven pattern or an engraved uneven pattern may be formed at the glass substrate 100, and may be formed using a dry or wet etching process. The etching process may use a method known in the art to which the present invention pertains. For example, the embossed uneven pattern or the engraved uneven pattern may be formed at the glass substrate 100 through a process including a first step of forming a resist layer on the glass substrate 100, a second step of patterning the resist layer to form a resist pattern layer for forming an embossed or engraved uneven pattern on the glass substrate 100, a third step of forming an embossed or engraved uneven pattern using the resist pattern layer as a mask, and a fourth step of removing the resist pattern layer. Subsequently, the glass substrate 100 having the embossed or engraved uneven pattern formed thereat may be strengthened, depending on circumstances.

The shape of the embossed or engraved uneven pattern formed at the glass substrate 100 is not limited, but may have a side surface perpendicular or inclined to a direction toward a front surface or a rear surface of the glass substrate 100 and may be a regularly continuous pattern or an irregular pattern vertically and horizontally arranged at the glass substrate 100.

The horizontal sectional shape of the embossed or engraved uneven pattern may be at least one of a polygonal shape, an oval shape, and a circular shape, or a combination thereof, and the embossed or engraved uneven pattern may be formed as a grid arrangement or cross arrangement pattern in order to improve folding properties and to uniformly disperse impact force.

The height h₃ of the embossed or engraved uneven pattern may be 1 to 50%, specifically 10 to 30%, of the thickness h₁ of the glass substrate 100. If the height is less than the above range, the impact force dispersion effect is insignificant, which is undesirable. If the height is greater than the above range, the overall strength may be reduced, which is also undesirable.

The width W₁ of the embossed or engraved uneven pattern may be 20 to 2000 μm, and the interval W₂ of the uneven pattern may be 30 to 4000 μm. If the width of the uneven pattern is greater than the above range, the folding properties may be reduced, and if the width of the uneven pattern is less than the above range, the pen drop properties may be reduced, which is undesirable. If the interval of the uneven pattern is greater than the above range, the pen drop properties may be reduced, and if the interval of the uneven pattern is less than the above range, the folding properties may be reduced, which is also undesirable. Specifically, the width of the embossed or engraved uneven pattern may be 100 to 1000 μm, and the interval of the uneven pattern may be 100 to 2000 μm.

The planar portion and the folding portion of the glass substrate 100 may have the same thickness, and the embossed or engraved uneven pattern may be formed at the front surface, the rear surface, or both surfaces of the glass substrate 100.

In general, the back side of the glass substrate 100 (i.e., the side opposite side to which impact is applied) is more vulnerable to pen drop impact. When the uneven pattern is formed at the rear surface of the glass substrate 100, therefore, impact may be more efficiently dispersed or absorbed by the uneven pattern than when the uneven pattern is formed at the front surface of the glass substrate 100, whereby impact resistance may be improved.

When the uneven pattern is formed at both surfaces of the glass substrate 100, impact force is primarily absorbed by the uneven pattern formed on the front surface, and the impact force transmitted into the glass substrate 100 is absorbed by the uneven pattern formed on the rear surface, whereby impact resistance may be further improved.

When the uneven pattern is formed on both surfaces of the glass substrate 100, the intervals, heights, etc. of the uneven patterns formed at the front surface and the rear surface may be equal to or different from each other depending on the specifications, use, etc. of a product.

The planar portion and the folding portion of the glass substrate 100 may have the same thickness, and the embossed or engraved uneven pattern may be formed at the folding portion of the glass substrate 100 or at both the planar portion and the folding portion of the glass substrate 100.

When the uneven pattern is formed at the planar portion and the folding portion of the glass substrate 100, impact is efficiently distributed or absorbed by the uneven pattern over a larger area than when the uneven pattern is formed at only the folding portion of the glass substrate 100, whereby impact resistance may be improved.

The planar portion and the folding portion of the glass substrate 100 may have the same thickness, the embossed or engraved uneven pattern may be formed at the front surface, the rear surface, or both surfaces of the glass substrate 100, and the embossed or engraved uneven pattern may be formed at the folding portion of the glass substrate 100 or at both the planar portion and the folding portion of the glass substrate 100.

The thickness of the glass substrate 100, i.e., the thickness of each of the planar portion and the folding portion, may be 10 to 300 μm. If the thickness is less than 10 μm, strength and manufacturing processability may be reduced, which is undesirable. If the thickness exceeds 300 μm, the folding properties may be reduced, which is also undesirable. Specifically, the thickness of the glass substrate 100 may be 20 to 200 μm.

An adhesive buffer layer 200 is formed at the front surface of the glass substrate 100, whereby the glass substrate 100 and a protective film layer 300 are adhered to each other. Deformation at the folding portion is minimized while an appropriate thickness and elasticity are maintained through the adhesive buffer layer 200, whereby impact resistance and durability may be improved.

The flexible cover window shown in FIG. 2A is configured to have a structure in which the glass substrate 100, the adhesive buffer layer 200, the protective film layer 300, and a hard coating layer 400 are sequentially stacked.

The adhesive buffer layer 200 is formed at the front surface of the glass substrate 100, whereby the glass substrate 100 and the protective film layer 300 are adhered to each other. Deformation at the folding portion is minimized while an appropriate thickness and elasticity are maintained through the adhesive buffer layer 200, whereby impact resistance and durability may be improved.

The adhesive buffer layer 200 may include a transparent resin that has a refractive index approximately equal to the refractive index of glass to which the adhesive buffer layer is applied, such as an optically clear resin (OCR). Examples of the transparent resin may include, but are not limited to, acrylic, epoxy, silicone, urethane, a urethane composite, a urethane-acrylic composite, hybrid sol-gel, and siloxane.

The thickness of the adhesive buffer layer 200 may be appropriately adjusted within a range of 1 to 50 μm depending on the composition and thickness of the protective film layer 300. When adhesion is performed within the above range, deformation at the folding portion is minimized while an appropriate thickness and elasticity are maintained through the adhesive buffer layer 200, whereby impact resistance and durability may be improved.

The adhesive buffer layer 200 may have a strength of 0.01 to 1 GPa in order to minimize deformation at the interface upon impact, such as pen drop, while increasing the surface hardness and adhesion to the glass substrate 100 to improve overall durability.

The protective film layer 300 is formed on the adhesive buffer layer 200, and the thickness or physical properties of the protective film layer may be adjusted, whereby it is possible to prevent scratches on the cover window and to improve the impact resistance, strength, and folding properties at the same time.

The protective film layer 300 is not limited as long as the protective film layer is made of a transparent rigid resin. For example, the protective film layer 300 may be made of at least one selected from the group consisting of polyethylene terephthalate (PET), transparent polyimide (TPI), polyurethane (PU), polypropylene (PP), polyethylene naphthalate (PEN), and polycarbonate (PC). Specifically, the protective film layer 300 may be made of PET or TPI, which has excellent transparency and flexibility. More specifically, the protective film layer 300 may be made of TPI, which has excellent heat resistance, chemical resistance, and durability, whereby it is possible to maintain inherent aesthetics of glass and to have an appropriate thickness to ensure strength while minimizing loosening or buckling problems that leave marks at the folding region after repeated folding. In particular, TPI has a surface hardness of about 5 to 6H when used simultaneously with the hard coating layer 400, which will be described below, and therefore TPI may also have excellent surface hardness properties, compared to PET, which has a surface hardness of 3 to 4H.

The strength of the protective film layer 300 at the planar portion and the strength of the protective film layer 300 at the folding portion may be equal to or different from each other.

The thickness of the protective film layer 300 may be 1 to 100 μm. Within the above thickness range, a surface hardness of 3H to 6H may be secured while the texture and tactile sensation inherent to glass are maintained, whereby strength may be increased while being thin, and folding properties may also be satisfied. If the thickness exceeds 100 μm, which is beyond the above range, the thickness of the cover window increases, and therefore the intended effect of the present invention may not be obtained, which is undesirable. If the thickness is less than 1 μm, processability may be reduced and the desired impact resistance may not be obtained, which is also undesirable. Specifically, the thickness of the protective film layer 300 may be 1 to 50 μm, more specifically 10 to 50 μm.

The hard coating layer 400 is formed on the protective film layer 300 such that impact force, such as pen drop, is supported and dispersed, thereby contributing to improvement of impact resistance to pen drop and puncture, improvement of folding properties, and increase in strength and surface hardness.

The hard coating layer (H/C) 400 may be formed by applying, for example, an acrylic resin, an epoxy resin, or a siloxane resin, which exhibits relatively high hardness when hardened. An anti-fingerprint (AF) or anti-reflective (AR) function may be imparted to the hard coating layer 400 as needed. For example, the anti-fingerprint (AF) or the anti-reflective (AR) function may be implemented by synthesizing a resin having such a function or by forming various patterns at the functional layer.

The thickness of the hard coating layer 400 may be 1 to 30 μm. If the thickness of the hard coating layer 400 is less than 1 μm, which deviates from the above range, it is difficult to achieve the impact force support and dispersion effect, which is undesirable. If the thickness of the hard coating layer 400 exceeds 30 μm, the thickness of the cover window increases and it is difficult to achieve the effect as a thin plate, which is also undesirable.

Referring to FIG. 2B showing an embodiment, depending on circumstances, an elastic buffer layer 500 may be optionally formed on the rear surface of the glass substrate 100 to minimize deformation at the folding portion while maintaining an appropriate thickness and elasticity, whereby it is possible to improve impact resistance and durability.

The elastic buffer layer 500 may include a transparent resin that has a refractive index approximately equal to the refractive index of glass to which the elastic buffer layer is applied, such as an optically clear resin (OCR). Examples of the transparent resin may include, but are not limited to, acrylic, epoxy, silicone, urethane, a urethane composite, a urethane-acrylic composite, hybrid sol-gel, and siloxane.

The elastic buffer layer 500 may have a strength of 0.01 to 1 GPa in order to minimize deformation at the interface upon impact, such as pen drop, while increasing the surface hardness and adhesion to the glass substrate 100 to improve overall durability.

The thickness of the elastic buffer layer 500 may be appropriately adjusted within a range of 1 to 50 μm depending on the composition and thickness of the elastic buffer layer 500. When adhesion is performed within the above range, deformation at the folding portion is minimized while an appropriate thickness and elasticity are maintained through the elastic buffer layer 500, whereby impact resistance and durability may be improved.

When no uneven pattern is formed at the rear surface of the glass substrate or when no inclined portion is formed at the rear surface of the glass substrate, however, the elastic buffer layer 500 is not preferably formed on the rear surface of the glass substrate such that the glass substrate is formed in the shape of a thin film in order to improve folding properties thereof.

2.1.2. Uneven Structure/One-Time Stacking/Planar Portion and Folding Portion Having Different Thicknesses

A flexible cover window according to an embodiment shown in FIG. 2C is configured such that an embossed uneven pattern is formed at a front surface of a folding portion of a glass substrate 100 and such that an inclined portion is located at a rear surface, whereby a planar portion and the folding portion have different thicknesses.

The embossed uneven pattern or an engraved uneven pattern may be formed at the glass substrate 100, and may be formed using a dry or wet etching process. The etching process may use a method known in the art to which the present invention pertains. For example, the embossed uneven pattern or the engraved uneven pattern may be formed at the glass substrate 100 through a process including a first step of forming a resist layer on the glass substrate 100, a second step of patterning the resist layer to form a resist pattern layer for forming an embossed or engraved uneven pattern on the glass substrate 100, a third step of forming an embossed or engraved uneven pattern using the resist pattern layer as a mask, and a fourth step of removing the resist pattern layer. Subsequently, the glass substrate 100 having the embossed or engraved uneven pattern formed thereat may be strengthened, depending on circumstances.

The shape of the embossed or engraved uneven pattern formed at the glass substrate 100 is not limited, but may have a side surface perpendicular or inclined to a direction toward a front surface or a rear surface of the glass substrate 100 and may be a regularly continuous pattern or an irregular pattern vertically and horizontally arranged at the glass substrate 100.

The horizontal sectional shape of the embossed or engraved uneven pattern may be at least one of a polygonal shape, an oval shape, and a circular shape, or a combination thereof, and the embossed or engraved uneven pattern may be formed as a grid arrangement or cross arrangement pattern in order to improve folding properties and to uniformly disperse impact force.

The height h₃ of the embossed or engraved uneven pattern may be 1 to 50%, specifically 10 to 30%, of the thickness h₁ of the glass substrate 100. If the height is less than the above range, the impact force dispersion effect is insignificant, which is undesirable. If the height is greater than the above range, the overall strength may be reduced, which is also undesirable.

The width W₁ of the embossed or engraved uneven pattern may be 20 to 2000 μm, and the interval W₂ of the uneven pattern may be 30 to 4000 μm. If the width of the uneven pattern is greater than the above range, the folding properties may be reduced, and if the width of the uneven pattern is less than the above range, the pen drop properties may be reduced, which is undesirable. If the interval of the uneven pattern is greater than the above range, the pen drop properties may be reduced, and if the interval of the uneven pattern is less than the above range, the folding properties may be reduced, which is also undesirable. Specifically, the width of the embossed or engraved uneven pattern may be 100 to 1000 μm, and the interval of the uneven pattern may be 100 to 2000 μm.

The shape of the embossed or engraved uneven pattern formed at the glass substrate 100 is not limited, but may have a side surface perpendicular or inclined to a direction toward a front surface or a rear surface of the glass substrate 100 and may be a regularly continuous pattern or an irregular pattern vertically and horizontally arranged at the glass substrate 100.

The horizontal sectional shape of the embossed or engraved uneven pattern may be at least one of a polygonal shape, an oval shape, and a circular shape, or a combination thereof, and the embossed or engraved uneven pattern may be formed as a grid arrangement or cross arrangement pattern in order to improve folding properties and to uniformly disperse impact force.

At least one surface of the folding portion of the glass substrate 100 includes an inclined portion, whereby the thickness of the folding portion may be less than the thickness of the planar portion.

The shape of the inclined portion formed at the folding portion of the glass substrate 100 is not limited as long as the inclined portion is formed so as to be concave from an outer surface of the folding portion in a thickness direction. For example, the inclined portion may have a shape that extends in a straight or curved line such that the thickness of the folding portion increases from a middle planar part of the glass toward an edge part of the glass. However, the shape of the inclined portion may also include, broadly speaking, the shape in which the middle planar part of the glass and the edge part of the glass extend perpendicular to each other.

In connection therewith, the inclined portion of the glass shown in FIG. 2C extends in a straight line such that the thickness of the folding portion increases from the middle planar part in a direction toward the edge part.

The inclined portion formed at the folding portion of the glass substrate 100 may be located at the rear surface, the front surface, or both surfaces. Specifically, when the inclined portion is formed at the rear surface of the glass substrate 100, the inclined portion may be a forward type inclined portion. When the inclined portion is formed at the front surface of the glass substrate 100, the inclined portion may be a reverse type inclined portion, which is a reversal of the forward type inclined portion. When the inclined portion is formed at the front surface and the rear surface of the glass substrate 100, the inclined portion may be a double-sided type inclined portion.

The depth h₂ of the inclined portion formed at the folding portion of the glass substrate 100 may be appropriately selected depending on the thickness h₁ of the glass substrate 100. For example, in the forward type inclined portion or the reverse type inclined portion, the depth of the inclined portion may be 5 to 70%, specifically 10 to 50%, more specifically 15 to 40%, of the thickness of the glass, i.e., the thickness of the planar portion. In the double-sided type inclined portion, the depth of the inclined portion may be 5 to 35%, specifically 10 to 30%, of the thickness of the glass, i.e., the thickness of the planar portion.

If the depth of the inclined portion formed at the folding portion is too large, which deviates from the above range, the thickness of the folding portion is too small, in which case, folding performance is good, but strength may be reduced and wrinkles may be easily generated, which is undesirable. If the depth of the inclined portion is too small, the thickness of the folding portion is too large, in which case, flexibility, resilience, and elasticity are reduced at the time of folding, resulting in poor folding performance, which is also undesirable.

In the reverse type inclined portion, in which the inclined portion is formed at the front surface of the glass substrate 100, an adhesive buffer layer 200 is formed thicker at the folding portion than in the forward type inclined portion, in which the inclined portion is formed at the rear surface of the glass substrate 100, to induce shock absorption, whereby pen drop properties and impact resistance may be excellent.

In the double-sided type inclined portion, in which the inclined portion is formed at the front surface and the rear surface of the glass substrate 100, the depth of the inclined portion at the front surface (the depth of a front part) and the depth of the inclined portion at the rear surface (the depth of a rear part) may be equal to or different from each other. Specifically, in the double-sided type inclined portion, the depth of the front part may be equal to the depth of the rear part, the depth of the front part may be greater than the depth of the rear part, or the depth of the front part may be less than the depth of the rear part.

At least one surface of the folding portion of the glass substrate 100 includes an inclined portion, whereby the thickness of the folding portion may be less than the thickness of the planar portion, and the embossed or engraved uneven pattern may be formed at the front surface, the rear surface, or both surfaces of the glass substrate 100.

In general, the back side of the glass substrate 100 (i.e., the side opposite side to which impact is applied) is more vulnerable to pen drop impact. When the uneven pattern is formed at the rear surface of the glass substrate 100, therefore, impact may be more efficiently dispersed or absorbed by the uneven pattern than when the uneven pattern is formed at the front surface of the glass substrate 100, whereby impact resistance may be improved.

When the uneven pattern is formed at both surfaces of the glass substrate 100, impact force is primarily absorbed by the uneven pattern formed on the front surface, and the impact force transmitted into the glass substrate 100 is absorbed by the uneven pattern formed on the rear surface, whereby impact resistance may be further improved.

When the uneven pattern is formed on both surfaces of the glass substrate 100, the intervals, heights, etc. of the uneven patterns formed at the front surface and the rear surface may be equal to or different from each other depending on the specifications, use, etc. of a product.

At least one surface of the folding portion of the glass substrate 100 includes an inclined portion, whereby the thickness of the folding portion may be less than the thickness of the planar portion, and the embossed or engraved uneven pattern may be formed at the folding portion of the glass substrate 100 or at both the planar portion and the folding portion of the glass substrate 100.

When the uneven pattern is formed at the planar portion and the folding portion of the glass substrate 100, impact is efficiently distributed or absorbed by the uneven pattern over a larger area than when the uneven pattern is formed at only the folding portion of the glass substrate 100, whereby impact resistance may be improved.

At least one surface of the folding portion of the glass substrate 100 includes an inclined portion, whereby the thickness of the folding portion may be less than the thickness of the planar portion, the embossed or engraved uneven pattern may be formed at the front surface, the rear surface, or both surfaces of the glass substrate 100, and the embossed or engraved uneven pattern may be formed at the folding portion of the glass substrate 100 or at both the planar portion and the folding portion of the glass substrate 100.

At the glass substrate 100, the thickness of the folding portion may be 5 to 100 μm, and the thickness of the planar portion may be 10 to 300 μm. If the thickness of the folding portion is less than 5 μm or the thickness of the planar portion is less than 10 μm, strength and manufacturing processability may be reduced, which is undesirable. If the thickness of the folding portion exceeds 100 μm or the thickness of the planar portion exceeds 300 μm, the folding properties may be reduced, which is also undesirable. Specifically, the thickness of the folding portion may be 10 to 80 μm, and the thickness of the planar portion may be 50 to 200 μm.

The glass substrate 100 may be made of chemically tempered glass.

The flexible cover window shown in FIG. 2C is configured to have a structure in which the glass substrate 100, the adhesive buffer layer 200, a protective film layer 300, and a hard coating layer 400 are sequentially stacked. The adhesive buffer layer 200, the protective film layer 300, and the hard coating layer 400 may have the same shapes as previously described.

Referring to FIG. 2D showing an embodiment, depending on circumstances, an elastic buffer layer 500 may be optionally formed on the rear surface of the glass substrate 100 to minimize deformation at the folding portion while maintaining an appropriate thickness and elasticity, whereby it is possible to improve impact resistance and durability.

The elastic buffer layer 500 may have the same shape as previously described.

When an uneven pattern is formed at the rear surface of the glass substrate or when an inclined portion is formed at the rear surface of the glass substrate, the elastic buffer layer 500 is preferably formed on the rear surface of the glass substrate in order to improve impact resistance and durability and to protect the uneven pattern and the inclined portion.

2.2. Uneven Structure/(n+1)-Time Stacking

FIGS. 2E and 2F are schematic views of flexible cover windows, each of which includes a glass substrate 100 having an embossed uneven pattern formed thereat and is configured such that an adhesive buffer layer and a protective film layer are alternately stacked twice.

The flexible cover window according to the present invention is configured such that the adhesive buffer layer and the protective film layer are alternately stacked at least n+1 times (where n is a natural number equal to or greater than 1), whereby rigidity against pen drop and puncture is increased while aesthetics and tactile sensation inherent to glass are maintained, and therefore it is possible to secure excellent strength and surface hardness.

In general, elongation must be higher and modulus must be lower with an increase in number of composite layers constituting the flexible cover window. Elongation is the ratio of the maximum length that glass can stretch until the glass is damaged when external force is applied to the glass, and modulus is an elastic modulus that indicates the degree of deformation of glass when external force is applied to the glass. A high modulus means that glass strongly resists deformation, and a low modulus means that glass easily deforms.

In the flexible cover window according to the present invention, a specific adhesive buffer layer and a specific protective film layer are alternately staked at least n+1 times (where n is a natural number equal to or greater than 1). Even though many composite layers are provided, therefore, the elongation may be high and the modulus may be low.

2.2.1. Uneven Structure/(n+1)-Time Stacking/Planar Portion and Folding Portion Having the Same Thickness

A flexible cover window according to an embodiment shown in FIG. 2E includes a glass substrate 100 having an embossed uneven pattern formed thereat and configured such that a planar portion and the folding portion have the same thickness or different thicknesses, and has a structure in which a first adhesive buffer layer 200, a first protective film layer 300, a second adhesive buffer layer 210, a second protective film layer 310, and a hard coating layer 400 are sequentially stacked.

The flexible cover window according to the embodiment shown in FIG. 2E is configured such that the embossed uneven pattern is located at a front surface of a folding portion of the glass substrate 100 and such that the planar portion and the folding portion have the same thickness.

The embossed uneven pattern or an engraved uneven pattern may be formed at the glass substrate 100, and may be formed using a dry or wet etching process. The etching process may use a method known in the art to which the present invention pertains. For example, the embossed uneven pattern or the engraved uneven pattern may be formed at the glass substrate 100 through a process including a first step of forming a resist layer on the glass substrate 100, a second step of patterning the resist layer to form a resist pattern layer for forming an embossed or engraved uneven pattern on the glass substrate 100, a third step of forming an embossed or engraved uneven pattern using the resist pattern layer as a mask, and a fourth step of removing the resist pattern layer. Subsequently, the glass substrate 100 having the embossed or engraved uneven pattern formed thereat may be strengthened, depending on circumstances.

The shape of the embossed or engraved uneven pattern formed at the glass substrate 100 is not limited, but may have a side surface perpendicular or inclined to a direction toward a front surface or a rear surface of the glass substrate 100 and may be a regularly continuous pattern or an irregular pattern vertically and horizontally arranged at the glass substrate 100.

The horizontal sectional shape of the embossed or engraved uneven pattern may be at least one of a polygonal shape, an oval shape, and a circular shape, or a combination thereof, and the embossed or engraved uneven pattern may be formed as a grid arrangement or cross arrangement pattern in order to improve folding properties and to uniformly disperse impact force.

The height h₃ of the embossed or engraved uneven pattern may be 1 to 50%, specifically 10 to 30%, of the thickness h₁ of the glass substrate 100. If the height is less than the above range, the impact force dispersion effect is insignificant, which is undesirable. If the height is greater than the above range, the overall strength may be reduced, which is also undesirable.

The width W₁ of the embossed or engraved uneven pattern may be 20 to 2000 μm, and the interval W₂ of the uneven pattern may be 30 to 4000 μm. If the width of the uneven pattern is greater than the above range, the folding properties may be reduced, and if the width of the uneven pattern is less than the above range, the pen drop properties may be reduced, which is undesirable. If the interval of the uneven pattern is greater than the above range, the pen drop properties may be reduced, and if the interval of the uneven pattern is less than the above range, the folding properties may be reduced, which is also undesirable. Specifically, the width of the embossed or engraved uneven pattern may be 100 to 1000 μm, and the interval of the uneven pattern may be 100 to 2000 μm.

The planar portion and the folding portion of the glass substrate 100 may have the same thickness, and the embossed or engraved uneven pattern may be formed at the front surface, the rear surface, or both surfaces of the glass substrate 100.

In general, the back side of the glass substrate 100 (i.e., the side opposite side to which impact is applied) is more vulnerable to pen drop impact. When the uneven pattern is formed at the rear surface of the glass substrate 100, therefore, impact may be more efficiently dispersed or absorbed by the uneven pattern than when the uneven pattern is formed at the front surface of the glass substrate 100, whereby impact resistance may be improved.

When the uneven pattern is formed at both surfaces of the glass substrate 100, impact force is primarily absorbed by the uneven pattern formed on the front surface, and the impact force transmitted into the glass substrate 100 is absorbed by the uneven pattern formed on the rear surface, whereby impact resistance may be further improved.

When the uneven pattern is formed on both surfaces of the glass substrate 100, the intervals, heights, etc. of the uneven patterns formed at the front surface and the rear surface may be equal to or different from each other depending on the specifications, use, etc. of a product.

The planar portion and the folding portion of the glass substrate 100 may have the same thickness, and the embossed or engraved uneven pattern may be formed at the folding portion of the glass substrate 100 or at both the planar portion and the folding portion of the glass substrate 100.

When the uneven pattern is formed at the planar portion and the folding portion of the glass substrate 100, impact is efficiently distributed or absorbed by the uneven pattern over a larger area than when the uneven pattern is formed at only the folding portion of the glass substrate 100, whereby impact resistance may be improved.

The planar portion and the folding portion of the glass substrate 100 may have the same thickness, the embossed or engraved uneven pattern may be formed at the front surface, the rear surface, or both surfaces of the glass substrate 100, and the embossed or engraved uneven pattern may be formed at the folding portion of the glass substrate 100 or at both the planar portion and the folding portion of the glass substrate 100.

The thickness of the glass substrate 100, i.e., the thickness of each of the planar portion and the folding portion, may be 10 to 300 μm. If the thickness is less than 10 μm, strength and manufacturing processability may be reduced, which is undesirable. If the thickness exceeds 300 μm, the folding properties may be reduced, which is also undesirable. Specifically, the thickness of the glass substrate 100 may be 20 to 200 μm.

An adhesive buffer layer 200 is formed at the front surface of the glass substrate 100, whereby the glass substrate 100 and the protective film layer 300 are adhered to each other. Deformation at the folding portion is minimized while an appropriate thickness and elasticity are maintained through the adhesive buffer layer 200, whereby impact resistance and durability may be improved.

The flexible cover window shown in FIG. 2E is configured to have a structure in which the glass substrate 100, the first adhesive buffer layer 200, the first protective film layer 300, the second adhesive buffer layer 210, the second protective film layer 310, and the hard coating layer 400 are sequentially stacked.

When the adhesive buffer layer and the protective film layer are alternately stacked at least n+1 times in a stacking direction, the compositions of n-th and (n+1)-th adhesive buffer layers may be identical to or different from each other, and the compositions of n-th and (n+1)-th protective film layers may be identical to or different from each other (where n is a natural number equal to or greater than 1). It is possible to secure the folding properties while implementing appropriate strength by adjusting the compositions of the alternately stacked layers.

Each of the first adhesive buffer layer 200 and the second adhesive buffer layer 210 may include a transparent resin that has a refractive index approximately equal to the refractive index of glass to which each adhesive buffer layer is applied, such as an optically clear resin (OCR). Examples of the transparent resin may include, but are not limited to, acrylic, epoxy, silicone, urethane, a urethane composite, a urethane-acrylic composite, hybrid sol-gel, and siloxane.

In an embodiment, the first adhesive buffer layer 200 may be made of an OCR, and the second adhesive buffer layer 210 may be made of an OCR.

The first protective film layer 300 or the second protective film layer 310 is not limited as long as the protective film layer is made of a transparent rigid resin. For example, the first protective film layer 300 or the second protective film layer 310 may be made of at least one selected from the group consisting of polyethylene terephthalate (PET), transparent polyimide (TPI), polyurethane (PU), polypropylene (PP), polyethylene naphthalate (PEN), and polycarbonate (PC). Specifically, the first protective film layer 300 or the second protective film layer 310 may be made of PET or TPI, which has excellent transparency and flexibility. More specifically, the first protective film layer 300 or the second protective film layer 310 may be made of TPI, which has excellent heat resistance, chemical resistance, and durability, whereby it is possible to maintain inherent aesthetics of glass and to have an appropriate thickness to ensure strength while minimizing loosening or buckling problems that leave marks at the folding region after repeated folding. In particular, TPI has a surface hardness of about 5 to 6H when used simultaneously with the hard coating layer 400, which will be described below, and therefore TPI may also have excellent surface hardness properties, compared to PET, which has a surface hardness of 3 to 4H.

In an embodiment, the first protective film layer 300 may be made of PET, and the second protective film layer 310 may be made of PET. In another embodiment, the first protective film layer 300 may be made of PET, and the second protective film layer 310 may be made of TPI. In a further embodiment, the first protective film layer 310 may be made of TPI, and the second protective film layer 320 may be made of TPI. However, if the first protective film layer is made of TPI and the second protective film layer is made of PET, i.e., if different types of protective film layers are used and TPI is formed inside the window, the difference in modulus between TPI and PET increases, whereby the degree of stretching or deformation increases depending on external conditions, causing a loss of strength, which is undesirable.

When the adhesive buffer layer 200 and the protective film layer 300 are alternately stacked at least n+1 times in a stacking direction, the thickness of an n-th adhesive buffer layer 200 may be less than the thickness of an (n+1)-th adhesive buffer layer 210, and the thickness of an n-th protective film layer 300 may be less than the thickness of an (n+1)-th protective film layer 310 (where n is a natural number equal to or greater than 1). It is possible to secure the folding properties while implementing appropriate strength by adjusting the thicknesses of the alternately stacked layers.

The thickness of the first adhesive buffer layer 200 or the second adhesive buffer layer 210 may be appropriately adjusted within a range of 1 to 50 μm depending on the composition and thickness of the protective film layer. When adhesion is performed within the above range, deformation at the folding portion is minimized while an appropriate thickness and elasticity are maintained through the adhesive buffer layer, whereby impact resistance and durability may be improved.

In an embodiment, the thickness of the first adhesive buffer layer 200 may be less than the thickness of the second adhesive buffer layer 210 within the above thickness range.

The thickness of the first protective film layer 300 or the second protective film layer 310 may be 1 to 100 μm. Within the above thickness range, a surface hardness of 3H to 6H may be secured while the texture and tactile sensation inherent to glass are maintained, whereby strength may be increased while being thin, and folding properties may also be satisfied. If the thickness exceeds 100 μm, which is beyond the above range, the thickness of the cover window increases, and therefore the intended effect of the present invention may not be obtained, which is undesirable. If the thickness is less than 1 μm, processability may be reduced and the desired impact resistance may not be obtained, which is also undesirable. Specifically, the thickness of the first protective film layer 300 or the second protective film layer 310 may be 1 to 50 μm, more specifically 10 to 50 μm.

In an embodiment, the thickness of the first protective film layer 300 may be less than the thickness of the second protective film layer 310 within the above thickness range.

The hard coating layer 400 is formed on the second protective film layer 310 such that impact force, such as pen drop, is supported and dispersed, thereby contributing to improvement of impact resistance to pen drop and puncture, improvement of folding properties, and increase in strength and surface hardness.

The hard coating layer (H/C) 400 may be formed by applying, for example, an acrylic resin, an epoxy resin, or a siloxane resin, which exhibits relatively high hardness when hardened. An anti-fingerprint (AF) or anti-reflective (AR) function may be imparted to the hard coating layer 400 as needed. For example, the anti-fingerprint (AF) or the anti-reflective (AR) function may be implemented by synthesizing a resin having such a function or by forming various patterns at the functional layer.

The thickness of the hard coating layer 400 may be 1 to 30 μm. If the thickness of the hard coating layer 400 is less than 1 μm, which deviates from the above range, it is difficult to achieve the impact force support and dispersion effect, which is undesirable. If the thickness of the hard coating layer 400 exceeds 30 μm, the thickness of the cover window increases and it is difficult to achieve the effect as a thin plate, which is also undesirable.

Referring to FIG. 2F showing an embodiment, depending on circumstances, an elastic buffer layer 500 may be optionally formed on the rear surface of the glass substrate 100 to minimize deformation at the folding portion while maintaining an appropriate thickness and elasticity, whereby it is possible to improve impact resistance and durability.

The elastic buffer layer 500 may include a transparent resin that has a refractive index approximately equal to the refractive index of glass to which the elastic buffer layer is applied, such as an optically clear resin (OCR). Examples of the transparent resin may include, but are not limited to, acrylic, epoxy, silicone, urethane, a urethane composite, a urethane-acrylic composite, hybrid sol-gel, and siloxane.

The elastic buffer layer 500 may have a strength of 0.01 to 1 GPa in order to minimize deformation at the interface upon impact, such as pen drop, while increasing the surface hardness and adhesion to the glass substrate 100 to improve overall durability.

The thickness of the elastic buffer layer 500 may be appropriately adjusted within a range of 1 to 50 μm depending on the composition and thickness of the elastic buffer layer 500. When adhesion is performed within the above range, deformation at the folding portion is minimized while an appropriate thickness and elasticity are maintained through the elastic buffer layer 500, whereby impact resistance and durability may be improved.

When no uneven pattern is formed at the rear surface of the glass substrate or when no inclined portion is formed at the rear surface of the glass substrate, however, the elastic buffer layer 500 is not preferably formed on the rear surface of the glass substrate such that the glass substrate is formed in the shape of a thin film in order to improve folding properties thereof.

2.2.2. Uneven Structure/(n+1)-Time Stacking/Planar Portion and Folding Portion Having Different Thicknesses

A flexible cover window according to an embodiment shown in FIG. 2G is configured such that an embossed uneven pattern is located at a front surface of a folding portion of a glass substrate 100 and such that an inclined portion is located at a rear surface, whereby a planar portion and the folding portion have different thicknesses.

The embossed uneven pattern or an engraved uneven pattern may be formed at the glass substrate 100, and may be formed using a dry or wet etching process. The etching process may use a method known in the art to which the present invention pertains. For example, the embossed uneven pattern or the engraved uneven pattern may be formed at the glass substrate 100 through a process including a first step of forming a resist layer on the glass substrate 100, a second step of patterning the resist layer to form a resist pattern layer for forming an embossed or engraved uneven pattern on the glass substrate 100, a third step of forming an embossed or engraved uneven pattern using the resist pattern layer as a mask, and a fourth step of removing the resist pattern layer. Subsequently, the glass substrate 100 having the embossed or engraved uneven pattern formed thereat may be strengthened, depending on circumstances.

The shape of the embossed or engraved uneven pattern formed at the glass substrate 100 is not limited, but may have a side surface perpendicular or inclined to a direction toward a front surface or a rear surface of the glass substrate 100 and may be a regularly continuous pattern or an irregular pattern vertically and horizontally arranged at the glass substrate 100.

The horizontal sectional shape of the embossed or engraved uneven pattern may be at least one of a polygonal shape, an oval shape, and a circular shape, or a combination thereof, and the embossed or engraved uneven pattern may be formed as a grid arrangement or cross arrangement pattern in order to improve folding properties and to uniformly disperse impact force.

The height h₃ of the embossed or engraved uneven pattern may be 1 to 50%, specifically 10 to 30%, of the thickness h₁ of the glass substrate 100. If the height is less than the above range, the impact force dispersion effect is insignificant, which is undesirable. If the height is greater than the above range, the overall strength may be reduced, which is also undesirable.

The width W₁ of the embossed or engraved uneven pattern may be 20 to 2000 μm, and the interval W₂ of the uneven pattern may be 30 to 4000 μm. If the width of the uneven pattern is greater than the above range, the folding properties may be reduced, and if the width of the uneven pattern is less than the above range, the pen drop properties may be reduced, which is undesirable. If the interval of the uneven pattern is greater than the above range, the pen drop properties may be reduced, and if the interval of the uneven pattern is less than the above range, the folding properties may be reduced, which is also undesirable. Specifically, the width of the embossed or engraved uneven pattern may be 100 to 1000 μm, and the interval of the uneven pattern may be 100 to 2000 μm.

At least one surface of the folding portion of the glass substrate 100 includes an inclined portion, whereby the thickness of the folding portion may be less than the thickness of the planar portion.

The shape of the inclined portion formed at the folding portion of the glass substrate 100 is not limited as long as the inclined portion is formed so as to be concave from an outer surface of the folding portion in a thickness direction. For example, the inclined portion may have a shape that extends in a straight or curved line such that the thickness of the folding portion increases from a middle planar part of the glass toward an edge part of the glass. However, the shape of the inclined portion may also include, broadly speaking, the shape in which the middle planar part of the glass and the edge part of the glass extend perpendicular to each other.

In connection therewith, the inclined portion of the glass shown in FIG. 2G extends in a straight line such that the thickness of the folding portion increases from the middle planar part in a direction toward the edge part.

The inclined portion formed at the folding portion of the glass substrate 100 may be located at the rear surface, the front surface, or both surfaces. Specifically, when the inclined portion is formed at the rear surface of the glass substrate 100, the inclined portion may be a forward type inclined portion. When the inclined portion is formed at the front surface of the glass substrate 100, the inclined portion may be a reverse type inclined portion, which is a reversal of the forward type inclined portion. When the inclined portion is formed at the front surface and the rear surface of the glass substrate 100, the inclined portion may be a double-sided type inclined portion.

The depth h₂ of the inclined portion formed at the folding portion of the glass substrate 100 may be appropriately selected depending on the thickness h₁ of the glass substrate 100. For example, in the forward type inclined portion or the reverse type inclined portion, the depth of the inclined portion may be 5 to 70%, specifically 10 to 50%, more specifically 15 to 40%, of the thickness of the glass, i.e., the thickness of the planar portion. In the double-sided type inclined portion, the depth of the inclined portion may be 5 to 35%, specifically 10 to 30%, of the thickness of the glass, i.e., the thickness of the planar portion.

If the depth of the inclined portion formed at the folding portion is too large, which deviates from the above range, the thickness of the folding portion is too small, in which case, folding performance is good, but strength may be reduced and wrinkles may be easily generated, which is undesirable. If the depth of the inclined portion is too small, the thickness of the folding portion is too large, in which case, flexibility, resilience, and elasticity are reduced at the time of folding, resulting in poor folding performance, which is also undesirable.

In the reverse type inclined portion, in which the inclined portion is formed at the front surface of the glass substrate 100, an adhesive buffer layer 200 is formed thicker at the folding portion than in the forward type inclined portion, in which the inclined portion is formed at the rear surface of the glass substrate 100, to induce shock absorption, whereby pen drop properties and impact resistance may be excellent.

In the double-sided type inclined portion, in which the inclined portion is formed at the front surface and the rear surface of the glass substrate 100, the depth of the inclined portion at the front surface (the depth of a front part) and the depth of the inclined portion at the rear surface (the depth of a rear part) may be equal to or different from each other. Specifically, in the double-sided type inclined portion, the depth of the front part may be equal to the depth of the rear part, the depth of the front part may be greater than the depth of the rear part, or the depth of the front part may be less than the depth of the rear part.

At least one surface of the folding portion of the glass substrate 100 includes an inclined portion, whereby the thickness of the folding portion may be less than the thickness of the planar portion, and the embossed or engraved uneven pattern may be formed at the front surface, the rear surface, or both surfaces of the glass substrate 100.

In general, the back side of the glass substrate 100 (i.e., the side opposite side to which impact is applied) is more vulnerable to pen drop impact. When the uneven pattern is formed at the rear surface of the glass substrate 100, therefore, impact may be more efficiently dispersed or absorbed by the uneven pattern than when the uneven pattern is formed at the front surface of the glass substrate 100, whereby impact resistance may be improved.

When the uneven pattern is formed at both surfaces of the glass substrate 100, impact force is primarily absorbed by the uneven pattern formed on the front surface, and the impact force transmitted into the glass substrate 100 is absorbed by the uneven pattern formed on the rear surface, whereby impact resistance may be further improved.

When the uneven pattern is formed on both surfaces of the glass substrate 100, the intervals, heights, etc. of the uneven patterns formed at the front surface and the rear surface may be equal to or different from each other depending on the specifications, use, etc. of a product.

At least one surface of the folding portion of the glass substrate 100 includes an inclined portion, whereby the thickness of the folding portion may be less than the thickness of the planar portion, and the embossed or engraved uneven pattern may be formed at the folding portion of the glass substrate 100 or at both the planar portion and the folding portion of the glass substrate 100.

When the uneven pattern is formed at the planar portion and the folding portion of the glass substrate 100, impact is efficiently distributed or absorbed by the uneven pattern over a larger area than when the uneven pattern is formed at only the folding portion of the glass substrate 100, whereby impact resistance may be improved.

At least one surface of the folding portion of the glass substrate 100 includes an inclined portion, whereby the thickness of the folding portion may be less than the thickness of the planar portion, the embossed or engraved uneven pattern may be formed at the front surface, the rear surface, or both surfaces of the glass substrate 100, and the embossed or engraved uneven pattern may be formed at the folding portion of the glass substrate 100 or at both the planar portion and the folding portion of the glass substrate 100.

At the glass substrate 100, the thickness of the folding portion may be 5 to 100 μm, and the thickness of the planar portion may be 10 to 300 μm. If the thickness of the folding portion is less than 5 μm or the thickness of the planar portion is less than 10 μm, strength and manufacturing processability may be reduced, which is undesirable. If the thickness of the folding portion exceeds 100 μm or the thickness of the planar portion exceeds 300 μm, the folding properties may be reduced, which is also undesirable. Specifically, the thickness of the folding portion may be 10 to 80 μm, and the thickness of the planar portion may be 50 to 200 μm.

The glass substrate 100 may be made of chemically tempered glass.

The flexible cover window shown in FIG. 2G is configured to have a structure in which the glass substrate 100, a first adhesive buffer layer 200, a first protective film layer 300, a second adhesive buffer layer 210, a second protective film layer 310, and a hard coating layer 400 are sequentially stacked. The first adhesive buffer layer 200, the first protective film layer 300, the second adhesive buffer layer 210, the second protective film layer 310, and the hard coating layer 400 may have the same shapes as previously described.

The adhesive buffer layer 200 is formed on the front surface of the glass substrate 100, whereby the glass substrate 100 and the protective film layer 300 are adhered to each other. Deformation at the folding portion is minimized while an appropriate thickness and elasticity are maintained through the adhesive buffer layer 200, whereby impact resistance and durability may be improved.

Referring to FIG. 2H showing an embodiment, depending on circumstances, an elastic buffer layer 500 may be optionally formed on the rear surface of the glass substrate 100 to minimize deformation at the folding portion while maintaining an appropriate thickness and elasticity, whereby it is possible to improve impact resistance and durability.

The elastic buffer layer 500 may have the same shape as previously described.

When an uneven pattern is formed at the rear surface of the glass substrate or when an inclined portion is formed at the rear surface of the glass substrate, the elastic buffer layer 500 is preferably formed on the rear surface of the glass substrate in order to improve impact resistance and durability and to protect the uneven pattern and the inclined portion.

Tables 1 to 4 below show the configuration of a flexible cover window according to an embodiment of the present invention. The configurations of flexible cover windows including glass described in the following examples may be applied to type I to IV flexible cover windows.

TABLE 1

| | Elastic | | Adhesive | Protective | Hard |
|---|---|---|---|---|---|
| | buffer | Glass | buffer | film | coating |
| Type | layer | thickness | layer | layer | layer |
| I | OCR | 30 μm or | OCR | PET or TPI | H/C |
| | | 50 μm | | | |

TABLE 2

| | Elastic | | Adhesive | Protective | Hard |
|---|---|---|---|---|---|
| | buffer | Glass | buffer | film | coating |
| Type | layer | thickness | layer | layer | layer |
| II | No | 30 μm or | OCR | PET or TPI | H/C |
| | | 50 μm | | | |

TABLE 3

| | | | n-th | | | | |
|---|---|---|---|---|---|---|---|
| | | | adhesive | n-th | (n + 1)-th | (n + 1)-th | Hard |
| | Elastic | Glass | buffer | protective | adhesive | protective | coating |
| Type | buffer layer | thickness | layer | film layer | buffer layer | film layer | layer |
| III | OCR | 30 μm or | OCR | PET or TPI | OCR | PET or TPI | H/C |
| | | 50 μm | | | | | |

(The case in which the n-th protective film layer is made of TPI and the (n+1)-th protective film layer is made of PET is excluded)

TABLE 4

| | | | n-th | | | | |
|---|---|---|---|---|---|---|---|
| | | | adhesive | n-th | (n + 1)-th | (n + 1)-th | Hard |
| | Elastic | Glass | buffer | protective | adhesive | protective | coating |
| Type | buffer layer | thickness | layer | film layer | buffer layer | film layer | layer |
| IV | No | 30 μm or | OCR | PET or TPI | OCR | PET or TPI | H/C |
| | | 50 μm | | | | | |

(The case in which the n-th protective film layer is made of TPI and the (n+1)-th protective film layer is made of PET is excluded.)

### EXAMPLES

The following tables show embodiments of a glass substrate applied to the flexible cover window according to the present invention, and FIGS. 3 to 12L are partial schematic views of flexible cover windows to which glass substrates according to embodiments of the present invention are applied.

In the embodiments shown in FIGS. 3 to 12L, three dots (see circular parts of FIG. 3) located at an upper side indicate that an adhesive buffer layer 200 and a protective film layer 300 may be alternately stacked at least n times. In an embodiment, the adhesive buffer layer and the protective film layer may be alternately stacked once or twice, as shown in FIG. 3. The number of stacking times is written at the end of the example number. For example, Example 1-1-1 means that the adhesive buffer layer and the protective film layer are alternately stacked once, and Example 1-1-2 means that the adhesive buffer layer and the protective film layer are alternately stacked twice.

In the embodiments shown in FIGS. 3 to 12L, a hard coating layer (not shown in FIGS. 3 to 12L) is located at the uppermost end of each of the flexible cover windows, in each of which the adhesive buffer layer and the protective film layer are alternately stacked once or twice.

In the embodiments shown in FIGS. 3 to 12L, an elastic buffer layer may be optionally formed on a rear surface of the glass substrate. In an example, for a glass substrate having an uneven pattern formed at the rear surface thereof or an inclined portion formed at the rear surface thereof, the elastic buffer layer is preferably formed on the rear surface of the glass substrate in order to improve impact resistance and durability and to protect the uneven pattern and the inclined portion. In another example, for a glass substrate having no uneven pattern formed at the rear surface thereof or no inclined portion formed at the rear surface thereof, no elastic buffer layer is preferably formed on the rear surface of the glass substrate such that the glass substrate is formed in the shape of a thin film in order to improve folding properties thereof.

TABLE 5

| | | | | | | Shape of |
|---|---|---|---|---|---|---|
| | | | | | | planar portion |
| | | | | | | and folding |
| | | Uneven pattern | | | | portion |
| | | Uneven | Position | Position | | Inclined |
| Example | FIG. | structure | 1 | 2 | Shape | portion |
| 1-1-1 | FIG. | No | | | | No |
| 1-1-2 | 3 | | | | | |
| 1-2-1 | FIG. | Yes | Folding portion | Front | Embossed | |
| 1-2-2 | 4A | | | surface | | |
| 1-3-1 | FIG. | | Both folding portion | Front | Embossed | |
| 1-3-2 | 4B | | and planar portion | | | |
| | | | (hereinafter referred to | surface | | |
| | | | as “entire region”) | | | |
| 1-4-1 | FIG. | | Folding portion | Front | Engraved | |
| 1-4-2 | 4C | | | surface | | |
| 1-5-1 | FIG. | | Entire region | Front | Engraved | |
| 1-5-2 | 4D | | | surface | | |
| 1-6-1 | FIG. | | Folding portion | Rear | Embossed | |
| 1-6-2 | 4E | | | surface | | |
| 1-7-1 | FIG. | | Entire region | Rear | Embossed | |
| 1-7-2 | 4F | | | surface | | |
| 1-8-1 | FIG. | | Folding portion | Rear | Engraved | |
| 1-8-2 | 4G | | | surface | | |
| 1-9-1 | FIG. | | Entire region | Rear | Engraved | |
| 1-9-2 | 4H | | | surface | | |
| 1-10-1 | FIG. | | Folding portion | Both | Embossed | |
| 1-10-2 | 4I | | | surfaces | | |
| 1-11-1 | FIG. | | Entire region | Both | Embossed | |
| 1-11-2 | 4J | | | surfaces | | |
| 1-12-1 | FIG. | | Folding portion | Both | Engraved | |
| 1-12-2 | 4K | | | surfaces | | |
| 1-13-1 | FIG. | | Entire region | Both | Engraved | |
| 1-13-2 | 4L | | | surfaces | | |

TABLE 6

| | | | | | | Shape of planar | |
|---|---|---|---|---|---|---|---|
| | | | | | | portion and folding | |
| | | Uneven pattern | | | | portion | |
| | | Uneven | Position | Position | | Inclined | |
| Example | FIG. | structure | 1 | 2 | Shape | portion | Position |
| 2-1-1 | FIG. | No | | | | Yes | Rear surface- |
| 2-1-2 | 5A | | | | | | forward |
| 2-2-1 | FIG. | No | | | | | Front surface- |
| 2-2-2 | 5B | | | | | | reverse |
| 2-3-1 | FIG. | Yes | Folding | Front | Embossed | | Rear surface- |
| 2-3-2 | 6A | | portion | surface | | | forward |
| 2-4-1 | FIG. | | Folding | Front | Embossed | | Front surface- |
| 2-4-2 | 6B | | portion | surface | | | reverse |
| 2-5-1 | FIG. | | Folding | Front | Engraved | | Rear surface- |
| 2-5-2 | 6C | | portion | surface | | | forward |
| 2-6-1 | FIG. | | Folding | Front | Engraved | | Front surface- |
| 2-6-2 | 6D | | portion | surface | | | reverse |
| 2-7-1 | FIG. | | Entire | Front | Embossed | | Rear surface- |
| 2-7-2 | 6E | | region | surface | | | forward |
| 2-8-1 | FIG. | | Entire | Front | Embossed | | Front surface- |
| 2-8-2 | 6F | | region | surface | | | reverse |
| 2-9-1 | FIG. | | Entire | Front | Engraved | | Rear surface- |
| 2-9-2 | 6G | | region | surface | | | forward |
| 2-10-1 | FIG. | | Entire | Front | Engraved | | Front surface- |
| 2-10-2 | 6H | | region | surface | | | reverse |
| 2-11-1 | FIG. | | Folding | Rear | Embossed | | Rear surface- |
| 2-11-2 | 6I | | portion | surface | | | forward |
| 2-12-1 | FIG. | | Folding | Rear | Embossed | | Front surface- |
| 2-12-2 | 6J | | portion | surface | | | reverse |
| 2-13-1 | FIG. | | Folding | Rear | Engraved | | Rear surface- |
| 2-13-2 | 6K | | portion | surface | | | forward |
| 2-14-1 | FIG. | | Folding | Rear | Engraved | | Front surface- |
| 2-14-2 | 6L | | portion | surface | | | reverse |
| 2-15-1 | FIG. | | Entire | Rear | Embossed | | Rear surface- |
| 2-15-2 | 6M | | region | surface | | | forward |
| 2-16-1 | FIG. | | Entire | Rear | Embossed | | Front surface- |
| 2-16-2 | 6N | | region | surface | | | reverse |
| 2-17-1 | FIG. | | Entire | Rear | Engraved | | Rear surface- |
| 2-17-2 | 6O | | region | surface | | | forward |
| 2-18-1 | FIG. | | Entire | Rear | Engraved | | Front surface- |
| 2-18-2 | 6P | | region | surface | | | reverse |
| 2-19-1 | FIG. | | Folding | Both | Embossed | | Rear surface- |
| 2-19-2 | 6Q | | portion | surfaces | | | forward |
| 2-20-1 | FIG. | | Folding | Both | Embossed | | Front surface- |
| 2-20-2 | 6R | | portion | surfaces | | | reverse |
| 2-21-1 | FIG. | | Folding | Both | Engraved | | Rear surface- |
| 2-21-2 | 6S | | portion | surfaces | | | forward |
| 2-22-1 | FIG. | | Folding | Both | Engraved | | Front surface- |
| 2-22-2 | 6T | | portion | surfaces | | | reverse |
| 2-23-1 | FIG. | | Entire | Both | Embossed | | Rear surface- |
| 2-23-2 | 6U | | region | surfaces | | | forward |
| 2-24-1 | FIG. | | Entire | Both | Embossed | | Front surface- |
| 2-24-2 | 6V | | region | surfaces | | | reverse |
| 2-25-1 | FIG. | | Entire | Both | Engraved | | Rear surface- |
| 2-25-2 | 6W | | region | surfaces | | | forward |
| 2-26-1 | FIG. | | Entire | Both | Engraved | | Front surface- |
| 2-26-2 | 6X | | region | surfaces | | | reverse |

TABLE 7

| | | | | | | Shape of planar portion | | |
|---|---|---|---|---|---|---|---|---|
| | | | | | | and folding portion | | |
| | | Uneven pattern | | | | | | Depth of front |
| | | Uneven | Position | Position | | Inclined | | part and rear |
| Example | FIG. | structure | 1 | 2 | Shape | portion | Position | part |
| 3-1-1 | FIG. | No | | | | Yes | Both | Front part = |
| 3-1-2 | 7 | | | | | | surfaces | Rear part |
| 3-2-1 | FIG. | Yes | Folding | Front | Embossed | | | |
| 3-2-2 | 8A | | portion | surface | | | | |
| 3-3-1 | FIG. | | Entire | Front | Embossed | | | |
| 3-3-2 | 8B | | region | surface | | | | |
| 3-4-1 | FIG. | | Folding | Front | Engraved | | | |
| 3-4-2 | 8C | | portion | surface | | | | |
| 3-5-1 | FIG. | | Entire | Front | Engraved | | | |
| 3-5-2 | 8D | | region | surface | | | | |
| 3-6-1 | FIG. | | Folding | Rear | Embossed | | | |
| 3-6-2 | 8E | | portion | surface | | | | |
| 3-7-1 | FIG. | | Entire | Rear | Embossed | | | |
| 3-7-2 | 8F | | region | surface | | | | |
| 3-8-1 | FIG. | | Folding | Rear | Engraved | | | |
| 3-8-2 | 8G | | portion | surface | | | | |
| 3-9-1 | FIG. | | Entire | Rear | Engraved | | | |
| 3-9-2 | 8H | | region | surface | | | | |
| 3-10-1 | FIG. | | Folding | Both | Embossed | | | |
| 3-10-2 | 8I | | portion | surfaces | | | | |
| 3-11-1 | FIG. | | Entire | Both | Embossed | | | |
| 3-11-2 | 8J | | region | surfaces | | | | |
| 3-12-1 | FIG. | | Folding | Both | Engraved | | | |
| 3-12-2 | 8K | | portion | surfaces | | | | |
| 3-13-1 | FIG. | | Entire | Both | Engraved | | | |
| 3-13-2 | 8L | | region | surfaces | | | | |

TABLE 8

| | | | | | | Shape of planar portion | | |
|---|---|---|---|---|---|---|---|---|
| | | | | | | and folding portion | | |
| | | | | | | | | Depth of |
| | | Uneven pattern | | | | | | front part |
| | | Uneven | Position | Position | | Inclined | | and rear |
| Example | FIG. | structure | 1 | 2 | Shape | portion | Position | part |
| 4-1-1 | FIG. | No | | | | Yes | Both | Front |
| 4-1-2 | 9 | | | | | | surfaces | part > |
| 4-2-1 | FIG. | Yes | Folding | Front | Embossed | | | Rear part |
| 4-2-2 | 10A | | portion | surface | | | | |
| 4-4-1 | FIG. | | Entire | Front | Embossed | | | |
| 4-4-2 | 10B | | region | surface | | | | |
| 4-4-1 | FIG. | | Folding | Front | Engraved | | | |
| 4-4-2 | 10C | | portion | surface | | | | |
| 4-5-1 | FIG. | | Entire | Front | Engraved | | | |
| 4-5-2 | 10D | | region | surface | | | | |
| 4-6-1 | FIG. | | Folding | Rear | Embossed | | | |
| 4-6-2 | 10E | | portion | surface | | | | |
| 4-7-1 | FIG. | | Entire | Rear | Embossed | | | |
| 4-7-2 | 10F | | region | surface | | | | |
| 4-8-1 | FIG. | | Folding | Rear | Engraved | | | |
| 4-8-2 | 10G | | portion | surface | | | | |
| 4-9-1 | FIG. | | Entire | Rear | Engraved | | | |
| 4-9-2 | 10H | | region | surface | | | | |
| 4-10-1 | FIG. | | Folding | Both | Embossed | | | |
| 4-10-2 | 10I | | portion | surfaces | | | | |
| 4-11-1 | FIG. | | Entire | Both | Embossed | | | |
| 4-11-2 | 10J | | region | surfaces | | | | |
| 4-12-1 | FIG. | | Folding | Both | Engraved | | | |
| 4-12-2 | 10K | | portion | surfaces | | | | |
| 4-14-1 | FIG. | | Entire | Both | Engraved | | | |
| 4-14-2 | 10L | | region | surfaces | | | | |

TABLE 9

| | | | | | | Shape of planar portion | | |
|---|---|---|---|---|---|---|---|---|
| | | | | | | portion and folding | | |
| | | Uneven pattern | | | | | | Depth of front |
| | | Uneven | Position | Position | | Inclined | | part and rear |
| Example | FIG. | structure | 1 | 2 | Shape | portion | Position | part |
| 5-1-1 | FIG. | No | | | | Yes | Both | Front part < |
| 5-1-2 | 11 | | | | | | surfaces | Rear part |
| 5-2-1 | FIG. | Yes | Folding | Front | Embossed | | | |
| 5-2-2 | 12A | | portion | surface | | | | |
| 5-5-1 | FIG. | | Entire | Front | Embossed | | | |
| 5-5-2 | 12B | | region | surface | | | | |
| 5-5-1 | FIG. | | Folding | Front | Engraved | | | |
| 5-5-2 | 12C | | portion | surface | | | | |
| 5-5-1 | FIG. | | Entire | Front | Engraved | | | |
| 5-5-2 | 12D | | region | surface | | | | |
| 5-6-1 | FIG. | | Folding | Rear | Embossed | | | |
| 5-6-2 | 12E | | portion | surface | | | | |
| 5-7-1 | FIG. | | Entire | Rear | Embossed | | | |
| 5-7-2 | 12F | | region | surface | | | | |
| 5-8-1 | FIG. | | Folding | Rear | Engraved | | | |
| 5-8-2 | 12G | | portion | surface | | | | |
| 5-9-1 | FIG. | | Entire | Rear | Engraved | | | |
| 5-9-2 | 12H | | region | surface | | | | |
| 5-10-1 | FIG. | | Folding | Both | Embossed | | | |
| 5-10-2 | 12I | | portion | surfaces | | | | |
| 5-11-1 | FIG. | | Entire | Both | Embossed | | | |
| 5-11-2 | 12J | | region | surfaces | | | | |
| 5-12-1 | FIG. | | Folding | Both | Engraved | | | |
| 5-12-2 | 12K | | portion | surfaces | | | | |
| 5-15-1 | FIG. | | Entire | Both | Engraved | | | |
| 5-15-2 | 12L | | region | surfaces | | | | |

### Experimental Example 1

Conditions of the flexible cover windows according to Comparative Example 1, Example 1-1-1, and Example 1-1-2 are shown in Table 10, and pen drop properties and puncture properties of the flexible cover windows were measured. The measured pen drop properties and puncture properties of the flexible cover windows are shown in Table 11. The pen drop properties were measured by dropping a pen having a weight of 13 g and a tip size of 0.5 mm, and the puncture properties were measured by dropping a pen having a tip size of 0.5 mm at a descending speed of 0.5 mm/min

TABLE 10

| | | Elastic | | Adhesive | Protective | Hard |
|---|---|---|---|---|---|---|
| | | buffer | Glass | buffer | film | coating |
| | Glass shape | layer | thickness | layer | layer | layer |
| Comparative | Without uneven | X | 30 μm | X | X | X |
| Example | structure, | | | | | |
| 1 | planar portion and | | | | | |
| | folding portion | | | | | |
| | having the same | | | | | |
| | thickness(bare) | | | | | |
| Example | Without uneven | X | 30 μm | OCR | PET | H/C |
| 1-1-1 | structure, | | | 5 μm | 38 μm | 6 μm |
| (FIG. 3) | planar portion and | | | | | |
| | folding portion | | | | | |
| | having the same | | | | | |
| | thickness | | | | | |

| | | | | First | First | Second | Second | |
|---|---|---|---|---|---|---|---|---|
| | | Elastic | | adhesive | protective | adhesive | protective | |
| | | buffer | Glass | buffer | film | buffer | film | coating |
| | Glass shape | layer | Thickness | layer | layer | layer | layer | layer |
| Example | Without uneven | X | 30 μm | OCR | PET | OCR | PET | H/C |
| 1-1-2 | structure, | | | 5 μm | 23 μm | 5 μm | 50 μm | 5 μm |
| (FIG. 3) | planar portion | | | | | | | |
| | and folding | | | | | | | |
| | portion having | | | | | | | |
| | the same | | | | | | | |
| | thickness | | | | | | | |

TABLE 11

| | Pen drop result | Puncture result |
|---|---|---|
| Comparative Example 1 (30 | 1 cm fail | 0.4 to 0.5 kgf |
| um glass substrate (bare)) | | |
| Example 1-1-1 (30 μm | 4 cm or less | 1.5 kgf or less |
| glass substrate) | | |
| Example 1-1-2 (30 μm | 15 cm or more | 3 kgf or more |
| glass substrate) | | |

In Table 10, Comparative Example 1 has a configuration including the glass alone, and Example 1-1-1 has a configuration in which the adhesive buffer layer and the protective film layer are alternately stacked once and the hard coating layer is formed at the uppermost end, as in FIG. 3. Example 1-1-2 has a configuration in which the adhesive buffer layer and the protective film layer are alternately stacked twice and the hard coating layer is formed at the uppermost end, as in FIG. 3.

According to Table 11, the pen drop test and puncture test are experiments to evaluate the durability, strength, surface hardness, etc. of glass, and it can be seen that the flexible cover window according to Example 1-1-2, in which the protective film layer was stacked twice, can resist impact when a pen is dropped from a height of at least 15 cm and is not damaged until a force of at least 3 kgf is applied thereto, thereby exhibiting excellent strength and surface hardness.

### Experimental Example 2

Meanwhile, conditions of the flexible cover windows according to Comparative Example 2, Example 2-11-2, and Example 2-12-2 are shown in Table 12, and pen drop properties and puncture properties of the flexible cover windows were measured. The measured pen drop properties and puncture properties of the flexible cover windows are shown in Table 12. The pen drop properties were measured by dropping a pen having a weight of 13 g and a tip size of 0.5 mm, and the puncture properties were measured by dropping a pen having a tip size of 0.5 mm at a descending speed of 0.5 mm/min.

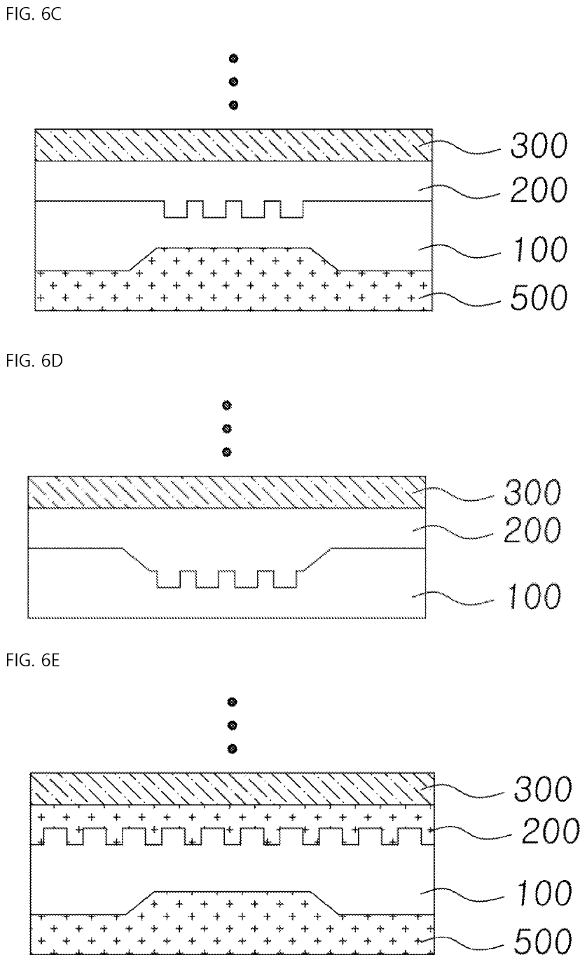

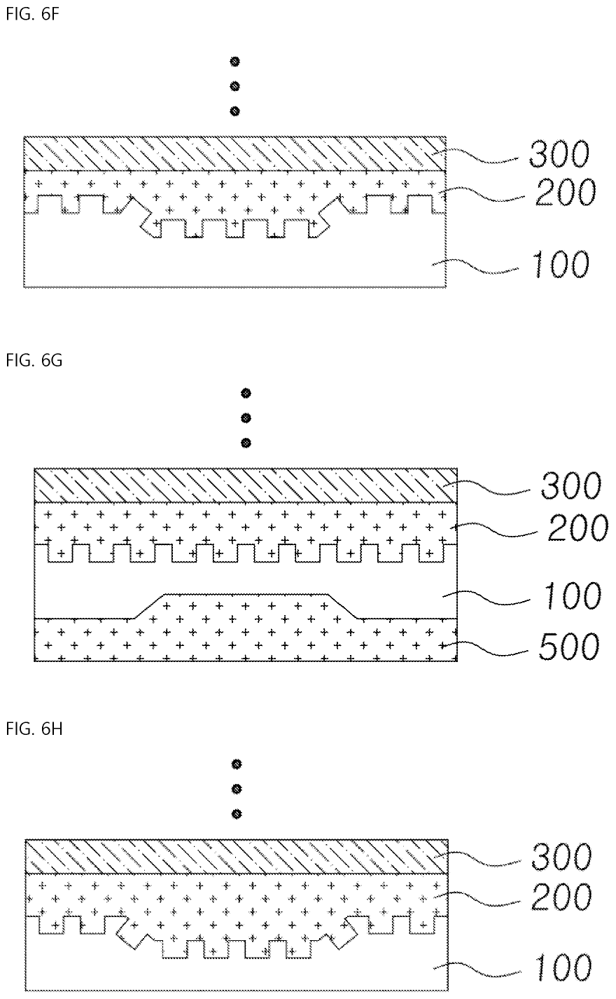

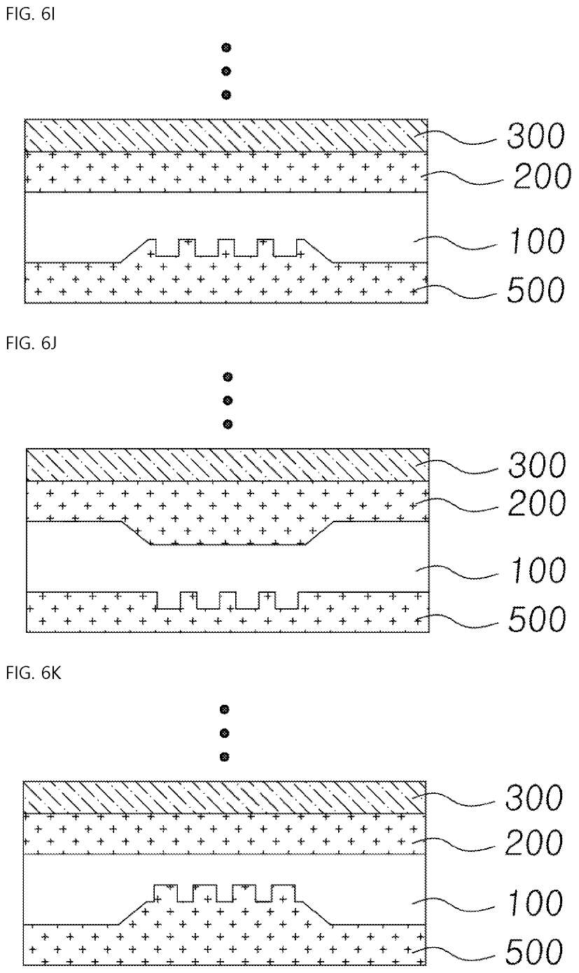

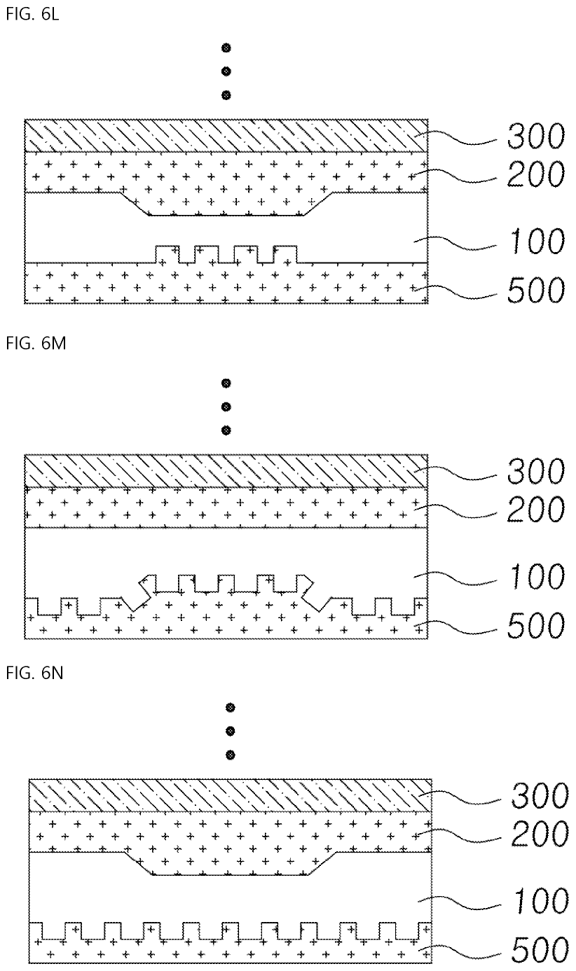

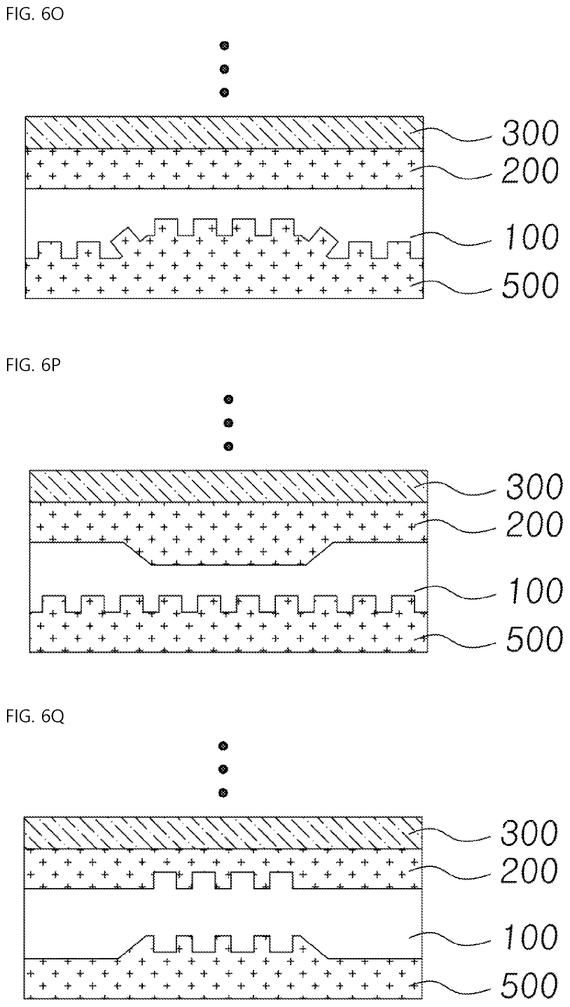

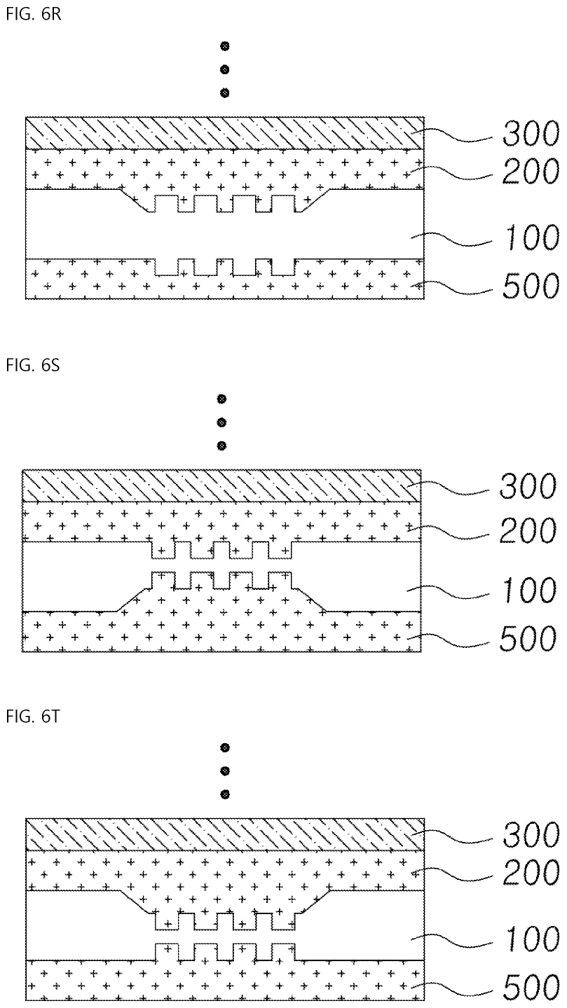

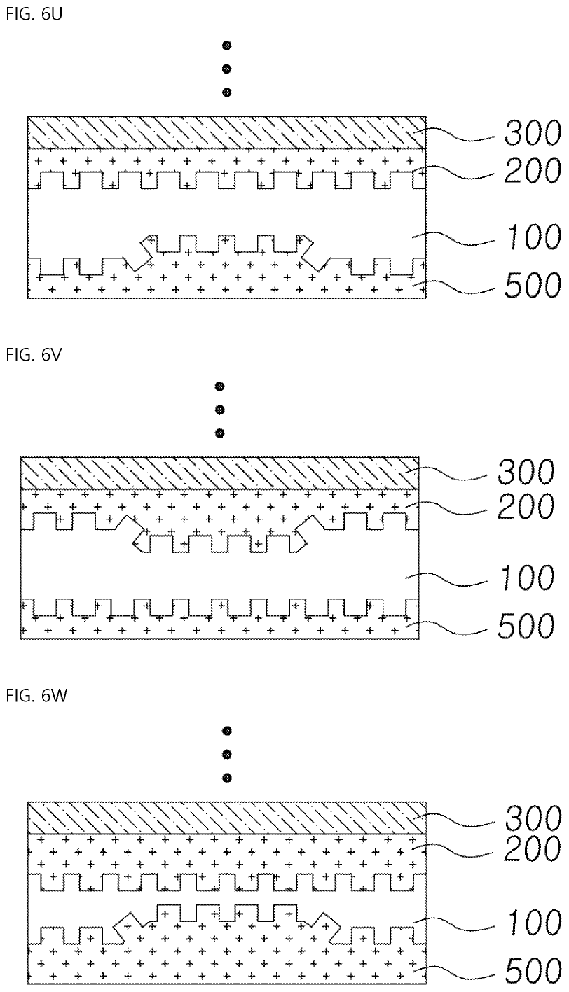

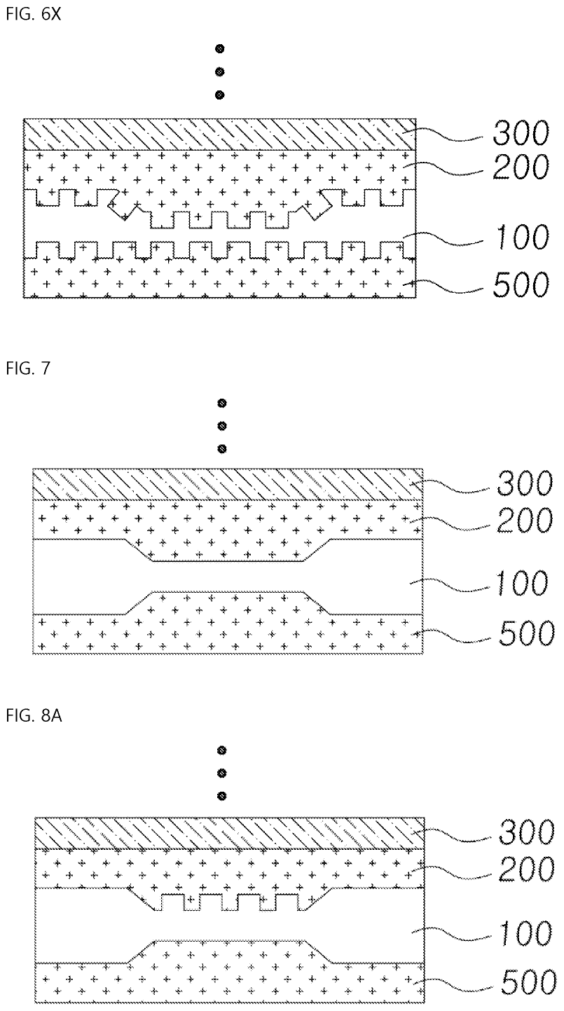

TABLE 12

| | | | | First | First | Second | Second | |
|---|---|---|---|---|---|---|---|---|
| | | Elastic | | adhesive | protective | adhesive | protective | Hard |
| | Glass | buffer | Glass | buffer | film | buffer | film | coating |
| | shape | layer | thickness | layer | layer | layer | layer | layer |
| Comparative | With uneven | O | 150/50 | X | X | X | X | X |
| Example 2 | structure (folding | | μm | | | | | |
| | portion, rear | | | | | | | |
| | surface, | | | | | | | |
| | embossed), planar | | | | | | | |
| | portion and folding | | | | | | | |
| | portion having | | | | | | | |
| | different | | | | | | | |
| | thicknesses | | | | | | | |
| | (inclined portion: | | | | | | | |
| | rear surface- | | | | | | | |
| | forward) | | | | | | | |
| Example | With uneven | O | 150/50 | OCR | PET | OCR | PET | H/C |
| 2-11-2 | structure (folding | | μm | 5 μm | 23 μm | 5 μm | 38 μm | 6 μm |
| (FIG. 6I) | portion, rear | | | | | | | |
| | surface, | | | | | | | |
| | embossed), planar | | | | | | | |
| | portion and folding | | | | | | | |
| | portion having | | | | | | | |
| | different | | | | | | | |
| | thicknesses | | | | | | | |
| | (inclined portion: | | | | | | | |
| | rear surface- | | | | | | | |
| | forward) | | | | | | | |
| Example | With uneven | X | 150/50 | OCR | PET | OCR | PET | H/C |
| 2-4-2 | structure (folding | | μm | 5 μm | 23 μm | 5 μm | 38 μm | 6 μm |
| (FIG. 6b) | portion, front | | | | | | | |
| | surface, | | | | | | | |
| | embossed), planar | | | | | | | |
| | portion and folding | | | | | | | |
| | portion having | | | | | | | |
| | different | | | | | | | |
| | thicknesses | | | | | | | |
| | (inclined portion: | | | | | | | |
| | front surface- | | | | | | | |
| | reverse) | | | | | | | |

TABLE 13

| | Pen drop result | Puncture result |
|---|---|---|
| Comparative Example 2 (50 | 1 cm fail | 0.5 kgf |
| um glass substrate(bare)) | | |
| Example 2-11-2 (50 μm | 15 cm or less | 5 kgf or more |
| glass substrate) | | |
| Example 2-12-2 (50 μm | 30 cm or more | 10 kgf or more |
| glass substrate) | | |

In Table 12, Comparative Example 2 has a configuration including the glass and the elastic buffer layer formed on the rear surface of the glass. Example 2-11-2 has a configuration in which the adhesive buffer layer and the protective film layer are alternately stacked twice and the hard coating layer is formed at the uppermost end, as in FIG. 61. Example 2-12-2 has a configuration in which the adhesive buffer layer and the protective film layer are alternately stacked twice and the hard coating layer is formed at the uppermost end, as in FIG. 6D.

In Table 12, the glass thickness is expressed as 150/50 μm, which means that, in glass configured such that the thickness of the planar portion and the thickness of the folding portion are different from each other, the thickness of the planar portion is 150 μm and the thickness of the folding portion having the uneven structure formed thereat is 50 μm.

The shape, height, width, and interval of the uneven pattern formed at the glass substrate shown in Table 12 may be selected from the foregoing.

The shape and depth of the inclined portion formed at the folding portion of the glass substrate shown in Table 12 may be selected from the foregoing.

According to Table 13, it can be seen that the flexible cover window according to Example 2-12-2 can resist impact when a pen is dropped from a height of at least 30 cm and is not damaged until a force of at least 10 kgf is applied thereto, thereby exhibiting excellent strength and surface hardness.

As is apparent from the above description, a flexible cover window according to the present invention is configured such that an adhesive buffer layer and a protective film layer, which is joined to the adhesive buffer layer, are formed at least once and a hard coating layer is formed at the uppermost end. Consequently, aesthetics and tactile sensation inherent to glass are maintained, and high pen drop properties and puncture properties are exhibited, whereby it is possible to provide excellent strength and surface hardness.

In addition, the flexible cover window according to the present invention may be formed in the shape of a thin film using a predetermined protective film layer, whereby it is possible to provide excellent strength and surface hardness while satisfying folding properties.

Furthermore, in the flexible cover window according to the present invention, impact force is dispersed using a glass substrate having a predetermined shape, whereby impact resistance is improved and rigidity against pen drop is increased, and therefore it is possible to provide excellent strength and surface hardness while satisfying folding properties.

What is claimed is:

1. A glass-based flexible cover window with improved strength and surface hardness comprising a planar portion formed so as to correspond to a planar region of a flexible display and a folding portion formed so as to be connected to the planar portion, the folding portion being formed so as to correspond to a folding region of the flexible display, wherein the flexible cover window comprises:
a flat glass substrate;
an adhesive buffer layer formed at a front surface of the glass substrate;
a protective film layer formed on the adhesive buffer layer; and
a hard coating layer formed on the protective film layer, and
the adhesive buffer layer and the protective film layer are alternately stacked at least n times (where n is a natural number equal to or greater than 1).

2. A glass-based flexible cover window with improved strength and surface hardness comprising a planar portion formed so as to correspond to a planar region of a flexible display and a folding portion formed so as to be connected to the planar portion, the folding portion being formed so as to correspond to a folding region of the flexible display, wherein the flexible cover window comprises:
a glass substrate having an embossed or engraved uneven pattern formed thereat;
an adhesive buffer layer formed at a front surface of the glass substrate;
a protective film layer formed on the adhesive buffer layer; and
a hard coating layer formed on the protective film layer, and
the adhesive buffer layer and the protective film layer are alternately stacked at least n times (where n is a natural number equal to or greater than 1).

3. The flexible cover window according to claim 1, wherein the planar portion and the folding portion of the glass substrate have the same thickness.

4. The flexible cover window according to claim 2, wherein
the planar portion and the folding portion of the glass substrate have the same thickness, and
the embossed or engraved uneven pattern is formed at the front surface, a rear surface, or both surfaces of the glass substrate.

5. The flexible cover window according to claim 2, wherein
the planar portion and the folding portion of the glass substrate have the same thickness, and
the embossed or engraved uneven pattern is formed at the folding portion of the glass substrate or at both the planar portion and the folding portion of the glass substrate.

6. The flexible cover window according to claim 1, wherein at least one surface of the folding portion of the glass substrate comprises an inclined portion, whereby a thickness of the folding portion is less than a thickness of the planar portion.

7. The flexible cover window according to claim 6, wherein the inclined portion of the folding portion is any one of:
a forward type inclined portion configured such that the inclined portion is formed at a rear surface of the glass substrate;
a reverse type inclined portion configured such that the inclined portion is formed at the front surface of the glass substrate, the reverse type inclined portion being a reversal of the forward type inclined portion; and
a double-sided type inclined portion configured such that the inclined portion is formed at the front surface and the rear surface of the glass substrate.

8. The flexible cover window according to claim 7, wherein the double-sided type inclined portion is configured such that a depth of the inclined portion formed at the front surface and a depth of the inclined portion formed at the rear surface are equal to or different from each other.

9. The flexible cover window according to claim 2, wherein
at least one surface of the folding portion of the glass substrate comprises an inclined portion, whereby a thickness of the folding portion is less than a thickness of the planar portion, and
the embossed or engraved uneven pattern is formed at the front surface, a rear surface, or both surfaces of the glass substrate.

10. The flexible cover window according to claim 2, wherein
at least one surface of the folding portion of the glass substrate comprises an inclined portion, whereby a thickness of the folding portion is less than a thickness of the planar portion, and
the embossed or engraved uneven pattern is formed at the folding portion of the glass substrate or at both the planar portion and the folding portion of the glass substrate.

11. The flexible cover window according to claim 2, wherein
the planar portion of the glass substrate has a thickness of 10 to 300 μm, and
the folding portion of the glass substrate has a thickness of 5 to 100 μm.

12. The flexible cover window according to claim 1, wherein the adhesive buffer layer comprises an optically clear resin (OCR).

13. The flexible cover window according to claim 1, wherein the protective film layer comprises at least one selected from a group consisting of polyethylene terephthalate (PET), transparent polyimide (TPI), polyurethane (PU), polypropylene (PP), polyethylene naphthalate (PEN), and polycarbonate (PC).

14. The flexible cover window according to claim 1, wherein a strength of the protective film layer at the planar portion and a strength of the protective film layer at the folding portion are equal to or different from each other.

15. The flexible cover window according to claim 1, wherein the protective film layer has a thickness of 1 to 100 μm.

16. The flexible cover window according to claim 1, wherein the flexible cover window is configured such that an elastic buffer layer is optionally formed on a rear surface of the glass substrate.

17. The flexible cover window according to claim 16, wherein the elastic buffer layer comprises an optically clear resin (OCR).

18. The flexible cover window according to claim 1, wherein
when the adhesive buffer layer and the protective film layer are alternately stacked at least n+1 times in a stacking direction,
compositions of n-th and (n+1)-th adhesive buffer layers are identical to or different from each other, and
compositions of n-th and (n+1)-th protective film layers are identical to or different from each other (where n is a natural number equal to or greater than 1).

19. The flexible cover window according to claim 1, wherein
when the adhesive buffer layer and the protective film layer are alternately stacked at least n+1 times in a stacking direction,
a thickness of an n-th adhesive buffer layer is less than a thickness of an (n+1)-th adhesive buffer layer, and
a thickness of an n-th protective film layer is less than a thickness of an (n+1)-th protective film layer (where n is a natural number equal to or greater than 1).

20. The flexible cover window according to claim 2, wherein the planar portion and the folding portion of the glass substrate have the same thickness.

21. The flexible cover window according to claim 2, wherein at least one surface of the folding portion of the glass substrate comprises an inclined portion, whereby a thickness of the folding portion is less than a thickness of the planar portion.

22. The flexible cover window according to claim 2, wherein the adhesive buffer layer comprises an optically clear resin (OCR).

23. The flexible cover window according to claim 2, wherein the protective film layer comprises at least one selected from a group consisting of polyethylene terephthalate (PET), transparent polyimide (TPI), polyurethane (PU), polypropylene (PP), polyethylene naphthalate (PEN), and polycarbonate (PC).

24. The flexible cover window according to claim 2, wherein a strength of the protective film layer at the planar portion and a strength of the protective film layer at the folding portion are equal to or different from each other.

25. The flexible cover window according to claim 2, wherein the protective film layer has a thickness of 1 to 100 μm.

26. The flexible cover window according to claim 2, wherein the flexible cover window is configured such that an elastic buffer layer is optionally formed on a rear surface of the glass substrate.

27. The flexible cover window according to claim 2, wherein
when the adhesive buffer layer and the protective film layer are alternately stacked at least n+1 times in a stacking direction,
compositions of n-th and (n+1)-th adhesive buffer layers are identical to or different from each other, and
compositions of n-th and (n+1)-th protective film layers are identical to or different from each other (where n is a natural number equal to or greater than 1).

28. The flexible cover window according to claim 2, wherein
when the adhesive buffer layer and the protective film layer are alternately stacked at least n+1 times in a stacking direction,
a thickness of an n-th adhesive buffer layer is less than a thickness of an (n+1)-th adhesive buffer layer, and
a thickness of an n-th protective film layer is less than a thickness of an (n+1)-th protective film layer (where n is a natural number equal to or greater than 1).

29. The flexible cover window according to claim 21, wherein the inclined portion of the folding portion is any one of:
a forward type inclined portion configured such that the inclined portion is formed at a rear surface of the glass substrate;
a reverse type inclined portion configured such that the inclined portion is formed at the front surface of the glass substrate, the reverse type inclined portion being a reversal of the forward type inclined portion; and
a double-sided type inclined portion configured such that the inclined portion is formed at the front surface and the rear surface of the glass substrate.

30. The flexible cover window according to claim 21, wherein the double-sided type inclined portion is configured such that a depth of the inclined portion formed at the front surface and a depth of the inclined portion formed at the rear surface are equal to or different from each other.

31. The flexible cover window according to claim 26, wherein the elastic buffer layer comprises an optically clear resin (OCR).
